(19) United States
(12) Patent Application Publication
(10) Pub. No.: US 2022/0085359 A1
(43) Pub. Date: Mar. 17, 2022

(54) ACTIVE MATERIAL, METHOD FOR PRODUCING ACTIVE MATERIAL, ELECTRODE AND BATTERY

(71) Applicant: CANON KABUSHIKI KAISHA, Tokyo (JP)

(72) Inventors: Kenta Kubo, Kanagawa (JP); Hiroshi Taniuchi, Kanagawa (JP)

(21) Appl. No.: 17/532,637

(22) Filed: Nov. 22, 2021

Related U.S. Application Data
(63) Continuation of application No. PCT/JP2020/021310, filed on May 29, 2020.

(30) Foreign Application Priority Data
May 31, 2019 (JP) 2019-103229
May 22, 2020 (JP) 2020-089616

(51) Int. Cl. H01M 4/36; H01M 10/0525; H01M 4/62; H01M 4/525; H01M 4/04

(52) U.S. Cl. CPC H01M 4/366; H01M 10/0525; H01M 2004/028; H01M 4/525; H01M 4/0471; H01M 4/62

(57) ABSTRACT

Provided is an active material including protruding portions protruding in a plurality of directions.

### CROSS-REFERENCE TO RELATED APPLICATIONS

This application is a Continuation of International Patent Application No. PCT/JP2020/021310, filed May 29, 2020, which claims the benefit of Japanese Patent Application No. 2019-103229, filed May 31, 2019, and Japanese Patent Application No. 2020-089616, filed May 22, 2020, all of which are hereby incorporated by reference herein in their entirety.

### BACKGROUND OF THE INVENTION

### Field of the Invention

The present invention relates to an active material, a method of producing an active material, an electrode, and a battery.

### Description of the Related Art

In general, a secondary battery is formed of electrodes (positive electrode and negative electrode) and an electrolyte, and performs charging and discharging by causing movement of ions between the electrodes via the electrolyte. Such a secondary battery is used in a wide range of applications from small equipment, for example, a mobile phone, to large equipment, for example, an electric vehicle. Accordingly, there is a demand for further improvement in performance of the secondary battery. In particular, in order to easily cause movement of ions between the electrodes via the electrolyte, there is a demand to increase an interface between the electrolyte and an active material in the electrode. In this case, the active material refers to a material involved in a reaction for generating electricity.

There is a description that, in order to increase the interface between the electrolyte and lithium cobalt oxide (LiCoO₂) serving as the active material in the positive electrode so as to improve a charge and discharge efficiency, LiCoO₂ obtained through crystallization by a flux method is used (see Journal of Materials Chemistry A, 2013, 00, 1-3, pp. 1-6). Further, there is a description that, when a charge and discharge rate of a sample structure in which lithium is used as the active material in the electrode and a solid electrolyte is used as the electrolyte is increased, needle-like active materials are protruding from the solid electrolyte (see “Special feature/Functioning of powder and development of new materials with nanotechnology,” Toyota Central R&D Labs., Inc., pp. 21-24).

Investigation was performed through use of, as the active material in the positive electrode, LiCoO₂ described in Journal of Materials Chemistry A, 2013, 00, 1-3, pp. 1-6, which was obtained through crystallization by the flux method. As a result, it was found that a value of an electrode resistance being an index representing the mobility of ions to the electrolyte was somewhat small, and hence, although the movement of ions to the electrolyte was caused, there was room for further improvement. Further, even when the sample structure described in “Special feature/Functioning of powder and development of new materials with nanotechnology,” Toyota Central R&D Labs., Inc., pp. 21-24, which had needle-like active materials protruding from the solid electrolyte, was used, the value of the electrode resistance was not sufficiently small, and hence ions were less likely to move to the electrolyte.

Thus, the present invention has an object to provide an active material with which an interface between the active material and an electrolyte can be increased and ions can easily move to the electrolyte, and to provide a method of producing the active material. Further, the present invention has another object to provide an electrode and battery using the active material.

### SUMMARY OF THE INVENTION

According to one aspect of the present invention, there is provided an active material including protruding portions protruding in a plurality of directions. According to one aspect of the present invention, there is provided an electrode including an active material and an electrolyte, and the active material includes protruding portions protruding in a plurality of directions.

According to one aspect of the present invention, there is provided a battery including a positive electrode active material, a negative electrode active material, and an electrolyte, and the positive electrode active material and the negative electrode active material each include protruding portions protruding in a plurality of directions.

According to one aspect of the present invention, there is provided a method of producing an active material including: a first step of forming, on a base material, a material layer in which an active material is arranged; a second step of laminating a plurality of material layers to form a laminated body; and a third step of subjecting the laminated body to sintering treatment to produce an active material.

Further features of the present invention will become apparent from the following description of exemplary embodiments with reference to the attached drawings.

### BRIEF DESCRIPTION OF THE DRAWINGS

FIG. 1 is a flow chart of a method of producing a positive electrode active material.

FIG. 2 is a view for schematically illustrating a configuration of a material layer forming apparatus 1.

FIG. 3 is a view for schematically illustrating a configuration of a filling device.

FIG. 4A is a view for schematically illustrating a filler conveyed on a first base material.

FIG. 4B is a view for schematically illustrating the filler conveyed on the first base material.

FIG. 4C is a view for schematically illustrating the filler conveyed on the first base material.

FIG. 5 is an enlarged view of the vicinity of the surface of the first base material in a filling process performed by a first filling device.

FIG. 6A is a view for schematically illustrating a configuration of a filling device in a case in which brush fibers are used as carrying materials.

FIG. 6B is a view for schematically illustrating a configuration of a filling device in a case in which an elastic material is used as a carrying material.

FIG. 7 is a view for schematically illustrating a configuration of a transfer portion.

FIG. 8 is an enlarged view of a vicinity of a surface of a second base material in a filling process performed by a second filling device.

FIG. 9A is a view for schematically illustrating the second base material obtained after first particles are transferred by the transfer portion.

FIG. 9B is a view for schematically illustrating the second base material obtained after second particles are transferred by the transfer portion.

FIG. 10 is a view for schematically illustrating a configuration of a material layer forming apparatus 2.

FIG. 11 is a view for schematically illustrating a configuration of a laminated body forming apparatus.

FIG. 12 is a view for schematically illustrating a configuration of a sintering treatment apparatus.

FIG. 13 is a view for schematically illustrating an overall configuration of an additive manufacturing system.

FIG. 14 is a graph for showing results of thermogravimetric analysis of polyethylene terephthalate (PET) coated with an acrylic pressure-sensitive adhesive, which corresponds to the second base material.

FIG. 15 is an image obtained by imaging, by an electron microscope, a laminated body obtained after base materials are removed.

FIG. 16 is an image obtained by imaging, by the electron microscope, heated lithium cobalt oxide (LCO).

FIG. 17 is an image obtained by imaging, by the electron microscope, a cross section of the laminated body obtained after the base materials are removed.

FIG. 18 is an image obtained by imaging, by the electron microscope, a positive electrode surface of a positive-pole electrode.

FIG. 19 shows results (Nyquist plot) of impedance measurement of an all-solid-state battery of Example 4.

FIG. 20 shows results of charge and discharge measurement (25° C.) of the all-solid-state battery of Example 4.

FIG. 21A is an image obtained by imaging, by the electron microscope, a cross section of a laminated body obtained before a heating step of removing base materials is performed.

FIG. 21B is an image obtained by imaging, by the electron microscope, the cross section of the laminated body obtained before the heating step of removing the base materials is performed.

FIG. 21C is an image obtained by imaging, by the electron microscope, a cross section of a laminated body obtained after the heating step of removing the base materials is performed.

FIG. 21D is an image obtained by imaging, by the electron microscope, the cross section of the laminated body obtained after the heating step of removing the base materials is performed.

FIG. 21E is an image obtained by imaging, by the electron microscope, the cross section of the laminated body obtained after the heating step of removing the base materials is performed.

### DESCRIPTION OF THE EMBODIMENTS

As a result of an investigation performed by the inventors of the present invention, it was found that it is important to increase a surface area of an active material in order to increase an interface between the active material and an electrolyte. Accordingly, the inventors decided to use an active material including protruding portions protruding in a plurality of directions. In this manner, it is considered that the surface area of the active material is increased, and the interface between the active material and the electrolyte is increased. Thus, ions can easily move from the active material to the electrolyte. In the present invention, for the sake of convenience, the mobility of ions from the active material to the electrolyte due to the increase of the interface between the active material and the electrolyte is evaluated through use of an index referred to as “electrode resistance.”

<Active Material>

Protruding portions protruding from a particle portion of an active material include needle-like protruding portions, dendritic protruding portions projecting like trees, folded protruding portions projecting like curtains, and the like. In some cases, the protruding portions are restated as projecting portions projecting from the particle portion. As the active material, there are given a positive electrode active material and a negative electrode active material. Of those, it is preferred that the active material be the positive electrode active material. It is preferred that the positive electrode active material include an oxide containing Li, and it is preferred that the oxide containing Li further contain Co. It is preferred that the positive electrode active material include lithium cobalt oxide (LiCoO₂).

Further, it is preferred that the protruding portions protruding in the plurality of directions include an oxide containing Li, and it is preferred that the oxide containing Li further contain Co. As described above, it is preferred that, in the active material, the protruding portions and parts other than the protruding portions include the same material.

<Method of Producing Active Material>

Now, with reference to the drawings, an example of a method of producing an active material is described in detail. In the following, a case in which a positive electrode active material is used as the active material is described as an example, but a method of producing an active material described below can be also applied to a case in which a negative electrode active material is used.

The method of producing a positive electrode active material of the present invention includes the following three steps (first step, second step, and third step).

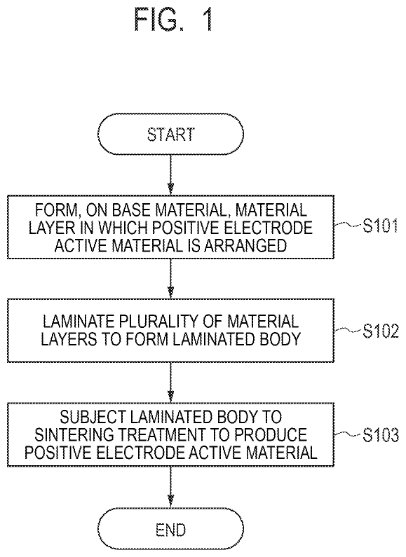

(1) A first step of forming, on a base material, a material layer in which a positive electrode active material is arranged (Step S101 of FIG. 1)
(2) A second step of laminating a plurality of material layers to form a laminated body (Step S102 of FIG. 1)
(3) A third step of subjecting the laminated body to sintering treatment to produce the positive electrode active material (Step S103 of FIG. 1)

(First Step)

The first step is a step of forming, on a base material, a material layer in which a positive electrode active material is arranged. In the first step, a material layer forming apparatus is used to form the material layer on the base material. Now, a material layer forming apparatus 1 and a material layer forming apparatus 2 which can be used as the material layer forming apparatus are sequentially described.

[Material Layer Forming Apparatus 1]

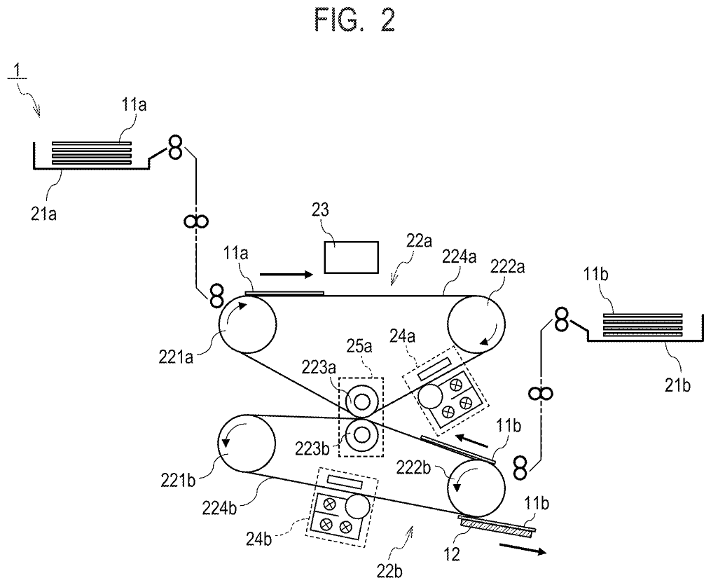

FIG. 2 is a view for schematically illustrating a configuration of the material layer forming apparatus 1. In the following, first particles P1 and second particles P2 both refer to the above-mentioned positive electrode active material. It is preferred that the first particles P1 and the second particles P2 be formed of elements of the same type.

The material layer forming apparatus 1 includes a first storage container 21a which stores and supplies a first base material 11a, a first belt device 22a which conveys the first base material 11a, and a pattern forming device 23 which forms an uneven pattern on the first base material 11a. The material layer forming apparatus 1 includes a first filling device 24a which arranges the first particles P1 in recessed portions of the uneven pattern formed on the first base material 11a. The material layer forming apparatus 1 includes a second storage container 21b which stores and supplies a second base material 11b, and a second belt device 22b which conveys the second base material 11b. The material layer forming apparatus 1 includes a transfer portion 25a at which rollers 223 of the respective first and second belt devices 22a and 22b are opposed to each other. At the transfer portion 25a, the first particles P1 are transferred from the first base material 11a onto the second base material 11b. Further, the material layer forming apparatus 1 includes a second filling device 24b which arranges the second particles P2 in non-transfer portions on the second base material 11b. Illustration and detailed description of devices having low relevance in terms of describing the effect of the subject application, for example, a separating and collecting device for separating and collecting the first base material 11a after transfer from the first belt device 22a, each cleaning device, and the like are omitted.

In the material layer forming apparatus 1, the pattern forming device 23, the first filling device 24a, and the transfer portion 25a correspond to first arranging means for arranging, on the second base material 11b, the first particles P1 in a pattern. Further, the second filling device 24b corresponds to second arranging means for arranging the second particles P2 in regions on the second base material 11b in which the first particles P1 are not arranged.

Now, a method of forming a material layer 12 onto the base material 11 by the material layer forming apparatus 1 is described along a flow of each process.

First, the first base material 11a is supplied from the first storage container 21a to the first belt device 22a by supplying means (not shown).

When UV-curable liquid is to be applied by the pattern forming device 23 (described later), it is preferred that a material of at least the surface of the first base material 11a be a material having a high wettability with respect to the UV-curable liquid. Further, it is preferred that the surface of the first base material 11a be smooth. As the first base material 11a, a sheet made of a resin, for example, polyester, which is subjected to hydrophilic treatment or lipophilic treatment in accordance with the used UV-curable liquid (water-based liquid or oil-based liquid) can be used. As the first base material 11a, a base material individually cut and separated like cut paper may be used, or a continuous base material which is rolled like roll paper or a continuous base material which is Z-folded like a continuous sheet may be used.

The first belt device 22a conveys the supplied first base material 11a to a pattern forming position of the pattern forming device 23. The first belt device 22a includes drive rollers 221a and 222a, a pressure roller 223a, and a belt-like conveying member 224a looped around those rollers. In this case, the pressure roller 223a is rotated in association with the other rollers.

It is preferred that the conveying member 224a be selected from a conveying member made of a resin, a conveying member made of a metal, or the like. For example, a resin belt made of polyimide can be used. It is preferred that metal rollers made of a metal be used as the drive rollers 221a and 222a. For example, metal rollers made of stainless steel can be used. It is preferred that a soft roller having an elastic layer as its surface layer be used as the pressure roller 223a. For example, a soft roller in which a silicone-rubber elastic layer is provided on a surface of a stainless-steel metal core can be used.

The first belt device 22a is used as a conveying device which conveys the first base material 11a, but a roller device can be used in place of the belt device. The same holds true for the second belt device 22b to be described later.

The pattern forming device 23 forms a fine uneven pattern on the first base material 11a conveyed to the pattern forming position. As a method of forming the uneven pattern, a UV imprint method, a thermal imprint method, a UV inkjet method, a printing method, a laser etching method, or the like can be used. When the pattern forming device 23 forms the uneven pattern by the UV imprint method, the pattern forming device 23 includes coating means for coating the first base material 11a with UV-curable liquid. Further, the pattern forming device 23 includes stamping means for stamping a mold having the uneven pattern formed on its surface on the UV-curable liquid formed on the first base material 11a, and a light source which irradiates ultraviolet rays to the UV-curable liquid. Typically, as the UV-curable liquid, a UV-curable liquid silicone rubber (PDMS) or resin can be used. As the mold, a film mold can be used. As the light source, a UV lamp can be used.

When the first filling device 24a fills the recessed portions with the first particles P1 through use of carrying materials S1 carrying the first particles P1, it is preferred that an opening diameter of the recessed portion of the uneven pattern on the first base material 11a be larger than a volume-based cumulative 50% particle diameter (median diameter) of the first particles P1. Further, it is preferred that the opening diameter of the recessed portion be smaller than an average size of the carrying materials S1. In this case, the opening diameter of the recessed portion of the uneven pattern is preferably an opening diameter in a short-side direction of the recessed portion, and is more preferably the maximum opening diameter in the short-side direction of the recessed portion. In this manner, the first particles P1 can be brought into contact with a bottom portion (typically, a bottom surface) of the recessed portion of the uneven pattern, but the carrying materials S1 cannot be brought into contact with the bottom portion of the recessed portion. In this manner, the first particles P1 brought into contact with the bottom portions of the recessed portions can be captured by the uneven pattern, whereas the carrying materials S1 can be prevented from being captured by the uneven pattern. In other words, it is preferred that the first particles P1 be able to be brought into contact with the bottom portions of the recessed portions of the uneven pattern, but the first carrying materials S1 be unable to be brought into contact with the bottom portions of the recessed portions of the uneven pattern.

The uneven pattern is formed on the first base material 11a by the pattern forming device 23, but a base material having an uneven pattern formed in advance on its surface may be used as the first base material 11a. Further, the uneven pattern may be formed by the pattern forming device 23 directly on the surface of the conveying member 224a of the first belt device 22a, or a conveying member having an uneven pattern on its surface may be used as the conveying member 224a. In this case, in view of durability, it is preferred that a metal belt made of stainless steel, aluminum, or the like be used, and that the uneven pattern be formed on the surface by a microfabrication technology such as laser etching, wet etching, dry etching, or the like.

The first base material 11a having the uneven pattern formed on its surface is conveyed by the first belt device 22a to a filling position of the first filling device 24a.

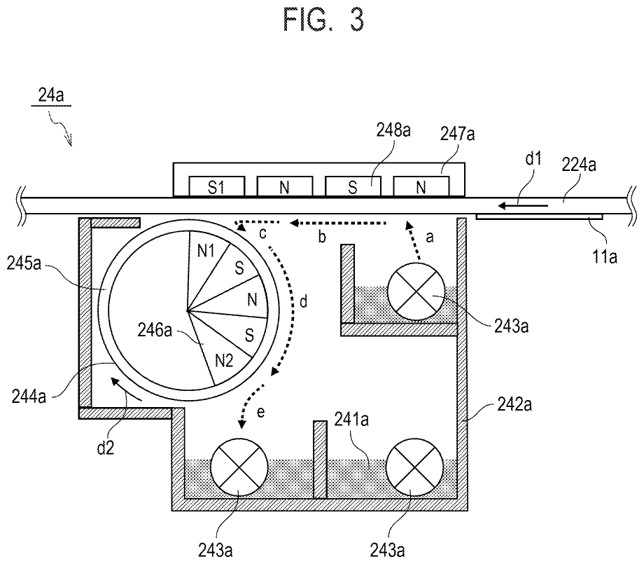

FIG. 3 is a view for schematically illustrating a configuration of the filling device. Now, the configuration of the first filling device 24a is described, but the same configuration is applied to the second filling device 24b.

The first filling device 24a includes a filling container 242a which stores a filler 241a, agitation screw members 243a which agitates and conveys the filler 241a, a collecting member 244a which collects the filler, and a magnetic member 247a.

The filler 241a includes the first particles P1 and the carrying materials S1 for carrying the first particles P1. The filler 241a is a mixture of a plurality of powders including a powder formed of a plurality of first particles P1 and a powder formed of a plurality of carrying materials S1. The filler 241a stored in the filling container 242a is sufficiently mixed and undergoes triboelectric charging when the filler 241a is agitated and conveyed by the agitation screw members 243a. In this manner, the first particles P1 are carried on the surfaces of the carrying materials S1.

The carrying materials S1 are magnetic particles. It is preferred that the carrying materials S1 be particles obtained by covering surfaces of resin particles in which ferrite core particles or magnetic bodies are dispersed with a resin composition. The particle diameter and the material of the carrying materials S1 are selected as appropriate in accordance with the particle diameter and the material of the first particles P1. In this manner, the first particles P1 can be stably carried.

The collecting member 244a includes a roller 245a rotatable in a direction of an arrow d2 of FIG. 3, and a magnet 246a which is arranged inside of the roller 245a, and is fixed with respect to the filling container 242a. Further, the magnetic member 247a is arranged so as to be opposed to the filling container 242a through intermediation of the conveying member 224a, and has a magnet 248a therein. The magnet 246a has a plurality of N poles and S poles alternately arranged along a rotation direction of the collecting member 244a. The magnet 248a has a plurality of N poles and S poles alternately arranged along a conveying direction of the conveying member 224a. Further, at a position closest to and opposed to the most downstream magnetic pole (S1 pole in this embodiment) of the magnet 248a, the magnet 246a has the other magnetic pole (N1 pole in this embodiment), and an N2 pole which is the same pole as the N1 pole is arranged at the most downstream position. The magnet 246a and the magnet 248a may each be formed of a plurality of magnets, and the type of the magnet forming each of the magnet 246a and the magnet 248a is not particularly limited. For example, permanent magnets such as ferrite magnets, rare-earth magnets including neodymium magnets and samarium cobalt magnets, and plastic magnets, and means for generating magnetic fields, for example, electromagnets, can be used. The magnet 248a may be configured to be movable in the conveying direction of the first base material 11a or in a direction opposite thereto.

A regulating member which regulates the filler 241a on the first base material 11a and a collecting member which further collects the filler 241a which is not completely collected by the collecting member 244a may be provided on the upstream or downstream side of the collecting member 244a in the conveying direction of the conveying member 224a. As the collecting member which further collects the filler, in addition to a member similar to the collecting member 244a, for example, a collecting member which performs collection from simple members such as a stationary magnet and the regulating member by air blowing can be used.

Next, a process of filling the recessed portions on the first base material 11a with the first particles P1 by the first filling device 24a is described with reference to FIG. 3 to FIG. 5.

The first conveying member 224a moves in a direction of a solid-line arrow d1 of FIG. 3. Thus, the first base material 11a carried and conveyed by the first conveying member 224a is conveyed, and is conveyed to the filling position of the first filling device 24a.

The filler 241a is conveyed by the agitation screw members 243a so as to be supplied onto the first base material 11a (dotted line “a” of FIG. 3). At this time, magnetic fields are formed by the magnetic member 247a and the collecting member 244a, and the filler 241a including the carrying materials S1 being magnetic particles forms a plurality of magnetic chains on the first base material 11a due to the magnetic fields. The filler 241a supplied on the first base material 11a is conveyed on the first base material 11a along with the movement of the first base material 11a under a state in which the magnetic chains are formed (dotted line “b” of FIG. 3).

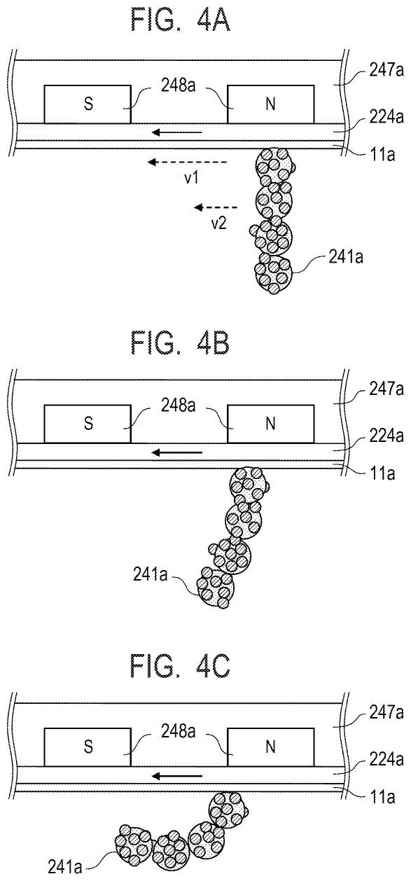

FIG. 4A to FIG. 4C are schematic views of the filler 241a conveyed on the first base material 11a. For the sake of description, illustration of the filler 241a other than the filler forming one magnetic chain is omitted. As described above, the filler 241a on the first base material 11a forms magnetic chains along the lines of magnetic force of the formed magnetic fields, and is conveyed while the shape of the magnetic chain is changed as illustrated in FIG. 4A, FIG. 4B, and FIG. 4C along with the movement of the first base material 11a. At this time, a particularly strong magnetic force acts in the vicinity of the magnet 248a, and hence a conveyance speed v2 of the filler 241a is smaller than a movement speed v1 of the first base material 11a in a case in which the filler 241a is separated away from the magnetic pole, and the conveyance speed v2 is larger than the movement speed v1 in the opposite case. That is, the filler 241a on the first base material 11a has a speed which is not 0 relative to the first base material 11a.

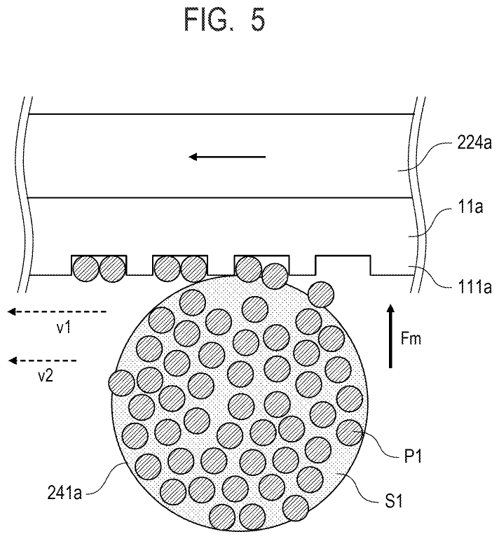

FIG. 5 is an enlarged view of the vicinity of the surface of the first base material 11a of FIG. 4A to FIG. 4C. Although illustration is omitted in FIG. 4A to FIG. 4C, as illustrated in FIG. 5, an uneven pattern 111a is formed on the first base material 11a. The filler 241a is brought into contact with the uneven pattern 111a, and is conveyed together with the first base material 11a while receiving a magnetic force (solid line Fm of FIG. 5) in a direction perpendicular to the surface of the first base material 11a and having a speed which is not 0 relative to the first base material 11a. In this manner, the first particles P1 carried by the carrying material S1 are conveyed while being rubbed against the uneven pattern 111a on the surface of the first base material 11a. At this time, the particle diameter of the first particle P1 is smaller than the opening diameter of the recessed portion of the uneven pattern 111a, and the particle diameter of the first carrying material S1 is larger than the opening diameter of the recessed portion. Thus, the first particles P1 can be brought into contact with the bottom surfaces (bottom portions) of the recessed portions of the uneven pattern 111a, but the carrying materials S1 cannot be brought into contact therewith. That is, in the filler 241a, only the first particles P1 are selectively brought into contact with the bottom surfaces of the recessed portions. The first particles P1 brought into contact with the bottom surfaces of the recessed portions are strongly retained by a physical restraining force obtained by the structure of the uneven pattern 111a and an electrostatic adhesive force and a pressure-sensitive adhesive force with respect to a structural material forming the first base material 11a and the uneven pattern 111a. Thus, the first particles P1 are released from the carrying materials S1.

As illustrated in FIG. 3, the collecting member 244a is arranged on the downstream of the magnetic member 247a so as to have a gap from the first conveying member 224a. The filler 241a conveyed to the vicinity of the most downstream magnetic pole (S1 pole) of the magnet 248a along with the movement of the first base material 11a moves from the first base material 11a to the collecting member 244a under the influence of the magnetic fields formed by the magnet 246a. Thus, the filler 241a is collected (dotted line “c” of FIG. 3).

As described above, in the conveyance process (dotted lines “a”, “b”, and “c” of FIG. 3), the recessed portions of the uneven pattern 111a on the surface of the first base material 11a are brought into sufficient contact with a plurality of fillers 241a. Accordingly, the first particles P1 are selectively and densely arranged in the recessed portions of the uneven pattern 111a after the filler 241a is collected by the collecting member 244a.

In FIG. 4A to FIG. 4C and FIG. 5, all first particles P1 are illustrated to have the same particle diameter. However, actually, there is a particle size distribution. Further, in some cases, aggregated secondary particles are formed depending on the material. Even in such cases, only particles which can be brought into contact with the bottom surfaces of the recessed portions of the uneven pattern 111a are selectively and densely introduced, and hence coarse powders, secondary particles, and the like which may adversely affect the formation of the material layer are excluded.

As described above, the filling amount of the first particles P1 into the recessed portion of the uneven pattern 111a can be controlled based on the size (area, width, and depth) of the recessed portion and the particle diameter of the first particle P1. Specifically, the area of the recessed portion substantially equals to a filling area, and a layer thickness of the introduced first particles P1 is determined depending on a depth of the recessed portion. For example, in order to obtain a thin layer (single layer) having an area of 50% with respect to the base material area, an area ratio of the recessed portions (area percentage of the recessed portions with respect to the overall uneven pattern) may be controlled to be 50%, and the depth of the recessed portion may be controlled to be equal to or smaller than the particle diameter of the first particle P1. At this time, an opening width of the recessed portion is set to be larger than the median diameter of the first particles P1, and smaller than the average size (in this case, average particle diameter) of the carrying materials S1. The first particles P1 may have a wide particle size distribution (broad particle size distribution), but the carrying materials S1 preferably have a narrow particle size distribution, and more preferably are monodisperse. In this manner, the carrying materials S1 are easily prevented from being brought into contact with the bottom portions (or the bottom surfaces) of the recessed portions. When the carrying materials S1 can be brought into contact with the bottom portions of the recessed portions, there is a fear in that the carrying materials S1 may also be retained by and introduced into the recessed portions.

Further, it is preferred that the opening width of the recessed portion of the uneven pattern 111a be smaller than 4 times the particle diameter of the first particle P1. When the opening width is set to be smaller than 4 times the particle diameter of the first particle P1, a probability for the first particle P1 to be brought into contact with two places, namely, a bottom surface and a side wall surface, of the recessed portion of the uneven pattern 111a can be increased. As described above, the first particle P1 brought into multipoint contact with the uneven pattern 111a is strongly retained by the uneven pattern 111a, and hence the efficiency of filling the uneven pattern 111a with the first particles P1 can be increased. The same holds true also for the particle diameter of the second particle P2 to be described later and a size of a recessed portion of an uneven pattern to be formed by the first particles P1. Further, when brush fibers are used as the carrying materials, the “average particle diameter of the carrying materials” in the above description refers to “average fiber diameter of the carrying materials.”

The filler 241a collected by the collecting member 244a is conveyed by the rotated roller 245a (dotted line “d” of FIG. 3). The filler 241a conveyed by the roller 245a is dropped into the filling container 242a under the influence of magnetic fields caused by two adjacent magnetic poles (N1 and N2) which have the same polarity and repel each other, and the gravity (dotted line “e” of FIG. 3). After that, agitation and conveyance are performed again by the agitation screw members 243a, and this operation is thereafter repeated.

A weight ratio between the first particles P1 and the carrying materials S1 in the filler 241a in the filling container 242a is determined by, for example, an inductance sensor which is generally included in electrophotographic apparatus, and performs measurement through use of magnetic permeability, or a patch density sensor which measures a reflection density of the surface of the base material or the like for estimation. Then, as required, at least one of the first particles P1 and the carrying materials S1 are replenished by replenishing means (not shown). In this manner, stable filling can be performed for a long period of time.

In this case, description has been given of the filling device employing the system in which the recessed portions are filled with particle materials through use of magnetic particles as the carrying materials so as to form so-called magnetic brushes. However, the system of the filling device is not limited thereto. Brush fibers can also be used as the carrying materials. As another example, an elastic material in which at least its surface is formed of an elastic body can be used as the carrying material.

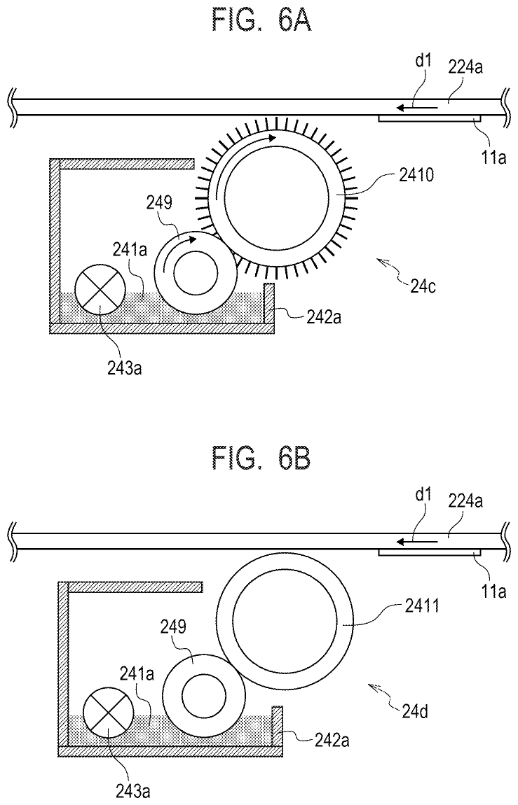

FIG. 6A is a view for schematically illustrating a configuration of a filling device 24c in a case in which brush fibers are used as the carrying materials.

The filling device 24c includes a roller 2410 having brush fibers on its surface. The roller 2410 is a so-called brush roller having brush fibers transplanted into its surface. As a material of fibers forming the brush fibers of the roller 2410, for example, nylon, rayon, acryl, vinylon, polyester, and vinyl chloride can be used. For the purpose of adjusting chargeability and stiffness, the surface of the fiber may be subjected to surface treatment.

The filling device 24c includes a supplying member which supplies the filler 241a to the roller 2410. The filler 241a includes a powder formed of a plurality of first particles P1, and is stored in the filling container 242a. Further, in this example, the filler 241a does not include the carrying materials S1 being magnetic particles. The filler 241a is agitated and conveyed by the agitation screw member 243a, and is supplied to a supplying member 249.

The supplying member 249 is a member which supplies the filler 241a to the roller 2410, and the configuration of the supplying member 249 is not particularly limited. As the supplying member 249, for example, a roller in which at least its surface is made of a porous foamed material having elasticity can be used. Typically, an elastic sponge roller obtained by forming, on a core metal, a polyurethane foam having a foamed skeleton structure and a relatively low hardness can be used. As a material of the foamed material, various rubber materials, such as nitrile rubber, silicone rubber, acrylic rubber, hydrin rubber, and ethylene propylene rubber, may be used in addition to urethane.

The supplied filler 241a is introduced into the foamed material on the surface of the supplying member 249. The filler 241a is thus conveyed to a supplying portion at which the filler 241a is brought into contact with the roller 2410. At the supplying portion, the filler 241a introduced into the foamed material is charged through contact with the brush fibers of the roller 2410, and is carried by the brush fibers of the roller 2410. Further, the supplying member 249 may also have a function of scraping off the filler 241a remaining on the roller 2410 so as to refresh the supplying member 249. The filler 241a supplied to the roller 2410 is brought into contact with the first base material 11a through movement of the brush fibers.

At this time, the first particles P1 in the filler 241a can be brought into contact with the bottom surfaces of the recessed portions of the uneven pattern 111a on the surface of the first base material 11a, but the brush fibers are prevented from being brought into contact therewith. That is, a fiber diameter of the brush fiber is set to be larger than the opening width of the recessed portion of the uneven pattern 111a. The fiber diameter of the brush fiber can be measured from an image of the brush fiber acquired by an optical microscope through glass placed on the surface of the roller 2410. At this time, the fiber diameters of about 100 brush fibers are measured, and the distribution of the fiber diameters is measured so that an average diameter is calculated.

The brush fibers of the roller 2410 are rubbed against the surface of the first base material 11a through the movement of the conveying member 224a and/or the rotation of the roller 2410. In this manner, the first particles carried by the brush fibers are densely arranged in the recessed portions of the uneven pattern 111a on the surface of the first base material 11a.

FIG. 6B is a view for schematically illustrating a configuration of a filling device 24d in a case in which an elastic material is used as the carrying material.

The filling device 24d has a configuration similar to that of the filling device 24c, but differs from the filling device 24c in that a roller 2411 including an elastic material is used in place of the roller 2410 including the brush fibers. The roller 2411 is a roller having an elastic layer formed on its surface. The elastic layer is made of a material having elasticity, for example, a rubber material such as silicone rubber, acrylic rubber, nitrile rubber, urethane rubber, or fluororubber. A surface shape of the elastic layer may be controlled by adding fine particles, for example, spherical resins. When the elastic layer has protruding portions on its surface, a size of the protruding portion of the elastic layer is set to be larger than the size of the recessed portion of the uneven pattern 111a. The size of the protruding portion of the elastic layer can be measured by a method similar to that for the fiber diameter of the brush fiber described above.

The elastic material on the surface of the roller 2411 is rubbed against the surface of the first base material 11a through the movement of the conveying member 224a and/or the rotation of the roller 2411. In this manner, the first particles carried by the elastic material are densely arranged in the recessed portions of the uneven pattern 111a on the surface of the first base material 11a.

Through use of the brush fibers and the elastic material as the carrying material as illustrated in FIG. 6A and FIG. 6B, it is not required to provide the magnetic particles into the filler, and the configuration of the filling device can be simplified. Meanwhile, when the magnetic particles are used as the carrying materials as illustrated in FIG. 3, the degree of freedom of the size or the shape of the carrying material is higher than that in the case of the brush fibers or the elastic material. In addition, in the case of the magnetic particles, the degree of freedom of movement of the carrying materials on the base material is high. For those reasons, when the magnetic particles are used as the carrying materials, the first particles P1 and other particles can be more efficiently supplied onto the base material, and the recessed portions on the base material can be more efficiently filled with the particles. Further, when the magnetic materials are used as the carrying materials, even in a case in which the carrying materials deteriorate in the middle of the process, the carrying materials can be replenished or replaced without stopping the process.

According to the method in which the recessed portions are filled with particles by rubbing the carrying materials carrying the particles, as compared to a filling method in which a regulating member, for example, a blade is used, a larger number of dispersed particles can be supplied to the recessed portions, and filling can be stably and densely performed. This advantage becomes remarkable as the particle diameter of the particle to be introduced is decreased because the particles are more likely to aggregate.

The first base material 11a having the first particles P1 introduced into the recessed portions of the uneven pattern 111a by the first filling device 24a is conveyed to the transfer portion 25a by the first belt device 22a.

In this case, as illustrated in FIG. 2, similarly to the first belt device 22a, the second belt device 22b includes drive rollers 221b and 222b, a pressure roller 223b, and a belt-like conveying member 224b looped around those rollers. At this time, the pressure roller 223b is rotated in association with the other rollers. At the transfer portion 25a, the pressure roller 223a of the first belt device 22a and the pressure roller 223b of the second belt device 22b are opposed to each other.

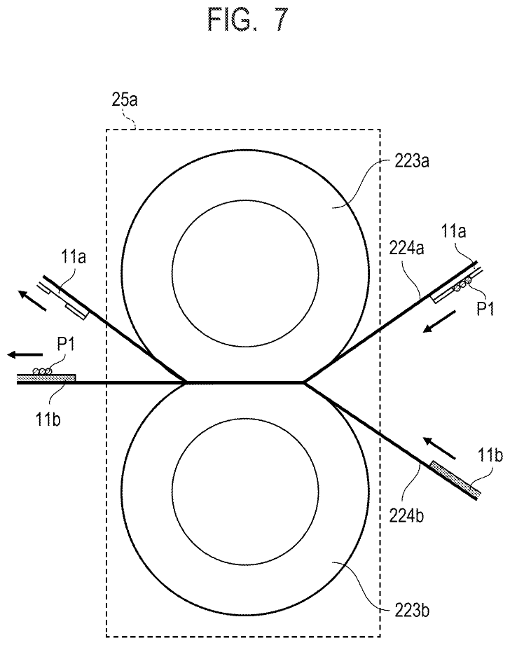

The second base material 11b is supplied from the second storage container 21b to the second belt device 22b, and is conveyed in a direction of the arrow of FIG. 2. The supplied second base material 11b is conveyed in synchronization with the timing at which the first base material 11a is conveyed to the transfer portion 25a. At the transfer portion 25a, the first particles P1 introduced into the first base material 11a are transferred onto the second base material 11b. That is, the first base material 11a can also be referred to as a transfer base material for use to transfer the first particles P1 onto the second base material 11b. Further, the uneven pattern formed on the surface of the first base material 11a can also be referred to as a transfer uneven pattern. Now, this transfer process is described with reference to FIG. 7.

FIG. 7 is a view for schematically illustrating a configuration of the transfer portion 25a. The transfer portion 25a includes the pressure roller 223a and the conveying member 224a of the first belt device 22a, and the pressure roller 223b and the conveying member 224b of the second belt device 22b. As described above, the pressure rollers 223a and 223b are rotated in association with the other rollers, and the two rollers are in contact with each other through intermediation of the conveying members 224a and 224b. At least one of the pressure rollers 223a and 223b is a soft roller having an elastic layer as its surface layer, and a nip portion is formed in a part in which the two rollers are in contact with each other.

The first base material 11a having the first particles P1 introduced thereon by the first filling device 24a and the second base material 11b are conveyed by the respective conveying members (224a and 224b) at substantially equal speeds, and enter the nip portion formed by the pressure rollers 223a and 223b being in contact with each other. At the nip portion, the first particles P1 on the first base material 11a are brought into contact with the second base material 11b, and are transferred onto the second base material 11b.

The second base material 11b is a base material having an adhesive force with respect to the first particles P1 larger than an adhesive force of the first base material 11a with respect to the first particles P1. In other words, an adhesive force of the first particles P1 with respect to the second base material 11b is larger than an adhesive force of the first particles P1 with respect to the first base material 11a. In this manner, at the nip portion, the first particles P1 on the first base material 11a are transferred onto the second base material 11b.

A material of the second base material 11b is not particularly limited, and a base material made of a material similar to that of the first base material 11a can be used. Similarly to the first base material 11a, the second base material 11b may be a base material individually cut and separated like cut paper, or a continuous base material which is rolled like roll paper or a continuous base material which is Z-folded like continuous paper.

It is preferred that the second base material 11b be subjected to surface treatment for the purpose of increasing the adhesive force so as to transfer the first particles P1 brought into contact therewith. For example, it is preferred that the second base material 11b have a pressure-sensitive adhesive layer coated with a pressure-sensitive adhesive on its front surface. Further, it is preferred that a back surface (surface on which the material layer is not formed) of the second base material 11b also have the same pressure-sensitive adhesive layer coated with the pressure-sensitive adhesive as that of the front surface. In this manner, misalignment between the base materials when the base materials are laminated can be prevented. In addition, upper and lower surfaces (laminating direction) of the positive electrode active material on the base material are sandwiched with the same materials, and hence degree of protrusion (uneven distribution of direction and variation in length) of the protruding portions protruding from the positive electrode active material become better.

The pressure-sensitive adhesive may be an acrylic pressure-sensitive adhesive, a rubber-based pressure-sensitive adhesive, or a silicone-based pressure-sensitive adhesive, or may be a thermoplastic resin, a photo-curable resin, or the like whose pressure-sensitive adhesive force is to be changed by disturbance such as heat or light. Both surfaces of the second base material 11b may be coated with the pressure-sensitive adhesive.

Further, the material layer forming apparatus 1 may have coating means such as a dispenser or an inkjet head, which coats the surface of the second base material 11b being conveyed with a pressure-sensitive adhesive.

A type and a coating amount of the pressure-sensitive adhesive are adjusted as appropriate based on, for example, the shape and the material of the uneven pattern to be used and the particle diameters and the materials of the first particles P1 and the second particles P2. It is preferred that the pressure-sensitive adhesive have a pressure-sensitive adhesive force larger than that of the uneven pattern 111a. The pressure-sensitive adhesive forces can be measured and compared by a general method using a nanoindenter.

At the nip portion, the first particles P1 are retained by the adhesive force generated between the first particles P1 and the second base material 11b. When both the conveying members 224a and 224b are separated apart from each other after passing the nip portion, the first particles P1 located on the first base material 11a are transferred onto the second base material 11b.

The second base material 11b having the first particles P1 transferred thereon is conveyed to a filling position of the second filling device 24b by the conveying member 224b.

The second filling device 24b has a configuration and a function similar to those of the first filling device 24a except that, inside of the filling container 242a, in place of the filler 241a including the first particles P1 and the carrying materials S1, a filler 241b including second particles P2 and carrying materials S2 is stored.

The second filling device 24b fills parts on the second base material 11b in which the first particles P1 are not arranged with the second particles P2. As described above, the first particles P1 are arranged on the second base material 11b which has passed through the transfer portion 25a, and, so to speak, recessed portions are formed in parts in which the first particles P1 are not arranged. The second filling device 24b fills those recessed portions with the second particles P2 through a process similar to that of the first filling device 24a. As described above, the second particles P2 which can be introduced into air gap portions on the base material 11b in which the first particles P1 are not arranged are selectively introduced, and hence a coverage of the base material by the particles is improved. It is preferred that the second particles P2 have a median diameter equal to or smaller than an opening width of the air gap portion between the first particles P1. In this case, description is given of a case in which magnetic particles are used as the carrying materials. However, similarly to the first filling device 24a, brush fibers or an elastic material may be used as the carrying material.

The filler 241b includes the second particles P2 and the carrying materials S2 for carrying the second particles P2. The filler 241b is a mixture of a plurality of powders including a powder formed of a plurality of second particles P2 and a powder formed of a plurality of carrying materials S2. As the carrying materials S2, materials similar to the carrying materials S1 can be used.

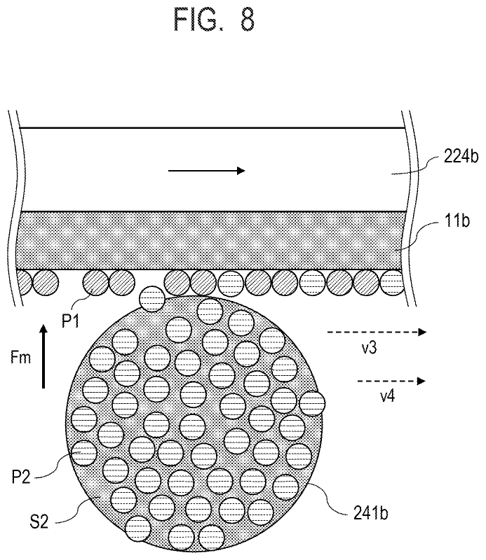

FIG. 8 is an enlarged view of the vicinity of the surface of the second base material 11b in the filling process performed by the second filling device 24b. On the second base material 11b, there is formed an uneven pattern including protruding portions formed by arranging the first particles P1 and recessed portions in which the first particles P1 are not arranged. The filler 241b is brought into contact with this uneven pattern, and is conveyed together with the second base material 11b while receiving a magnetic force (solid line Fm of FIG. 8) in a direction perpendicular to the surface of the second base material 11b and having a speed which is not 0 relative to the second base material 11b. In this manner, the second particles P2 carried by the carrying materials S2 are conveyed while being rubbed against the uneven pattern on the surface of the second base material 11b. At this time, an opening width of the recessed portion of the uneven pattern formed on the second base material 11b is set to be a size which allows the second particles P2 to be in contact with the bottom surface of the recessed portion (second base material 11b), but which does not allow the carrying materials S2 to be in contact therewith. In this manner, in the filler 241b, only the second particles P2 are selectively brought into contact with the bottom surfaces of the recessed portions (second base material 11b). The second particles P2 brought into contact with the bottom surfaces of the recessed portions are strongly retained by a physical restraining force obtained by the structure of the uneven pattern and an electrostatic adhesive force and a pressure-sensitive adhesive force with respect to the second base material 11b and a structural material (in this case, first particles P1) forming the uneven pattern. Thus, the second particles P2 are released from the carrying materials S2.

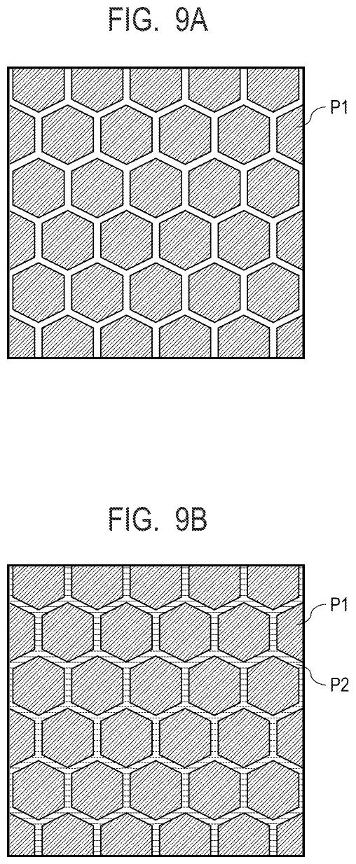

FIG. 9A is a view for schematically illustrating the second base material 11b obtained after the first particles P1 are transferred by the transfer portion 25a, and is a view obtained by viewing the second base material 11b in the direction perpendicular to the surface of the base material. As illustrated in FIG. 9A, on the second base material 11b, there is formed a honeycomb pattern in which arrangement regions in each of which the first particles P1 are arranged in a regular hexagonal shape are arrayed. The first particles P1 are densely arranged in the regular hexagonal region, and the first particles P1 are not arranged in a part other than the arrangement regions (white background part of FIG. 9A) so that the surface of the second base material 11b is exposed. In other words, the regular hexagonal regions in which the first particles P1 are held is a first pattern portion, and a honeycomb pattern region in which the second particles P2 are held and which corresponds to a gap in the first pattern portion is a second pattern portion.

FIG. 9B is a view for schematically illustrating the second base material 11b obtained after the second particles P2 are introduced by the second filling device 24b, and is a view obtained by viewing the second base material 11b in the direction perpendicular to the surface of the base material. As illustrated in FIG. 9B, the second particles P2 are densely arranged in the region in which the first particles P1 are not arranged. Further, the first particles P1 and the second particles P2 are densely arranged even at boundary portions between the region in which the first particles P1 are arranged and the region in which the second particles P2 are arranged. Slight gaps between the first particles P1 can also be filled with particles by a similar method. In this case, filling can be performed by a method similar to the above-mentioned method through use of a filler including particles having particle diameters corresponding to the gap between the first particles P1. Thus, a denser thin film can be formed.

It is preferred that the base material 11 be applied with liquid including a material which allows the positive electrode active material to adhere thereto. Further, it is preferred that the base material 11 including a material which allows the positive electrode active material to adhere thereto be used.

[Material Layer Forming Apparatus 2]

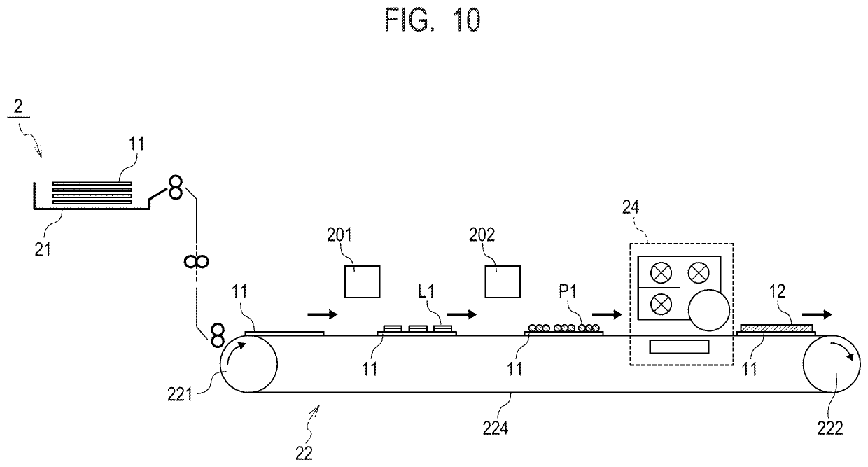

FIG. 10 is a view for schematically illustrating a configuration of the material layer forming apparatus 2. The material layer forming apparatus 2 is an apparatus which forms a material layer 12 on a base material 11, and includes a storage container 21 which stores and supplies the base material 11 and a belt device 22 which conveys the base material 11. Further, the material layer forming apparatus 2 includes a liquid applying device 201 which arranges liquid on the base material 11. When the material layer 12 is formed on the base material 11, in order to densely arrange the positive electrode active material on the base material 11, it is preferred that the liquid be arranged in a pattern on the base material 11.

As the liquid applying device 201, a device which ejects liquid in an inkjet system or a device which performs liquid coating can be used. As another example, a method using plates, for example, a flexographic plate, can be used. Of those, as the liquid applying device, it is preferred that the device which ejects liquid by the inkjet system be used.

As the device which ejects liquid by the inkjet system, for example, devices employing various ejection methods such as a thermal-type device, a piezoelectric-type device, an electrostatic-type device, and a continuous-type device can be used.

Liquid to be applied by the liquid applying device 201 may be aqueous liquid or oily liquid as long as the liquid contains a material which allows the positive electrode active material to adhere thereto. Further, the liquid applying device 201 may form a pattern L1 through use of a plurality of types of liquid. For example, the liquid applying device 201 may apply two types of liquid which react on the base material 11 so as to increase the pressure-sensitive adhesive property. As the material which allows the positive electrode active material to adhere thereto, a resin, for example, an acrylic resin, can be given.

A powder applying device 202 applies a powder including the positive electrode active material to the base material 11 on which the liquid is arranged in a pattern. In this manner, the positive electrode active material is fixed by the material which allows the positive electrode active material to adhere thereto in the liquid on the base material 11, and the positive electrode active material is fixed in a pattern corresponding to the pattern L1.

As means for applying powder by the powder applying device 202, means for blowing or sprinkling the powder toward the base material 11 can be used. The powder applying device 202 may further include means for removing the positive electrode active material which has not been fixed to the base material 11 by the liquid, by means of vibration, air blowing, suction, or the like.

The material layer forming apparatus 2 may further include a drying device which controls an amount of liquid on the base material 11, a thickness of the pattern L1, and the like by vaporizing at least part of the liquid applied by the liquid applying device 201. The drying device may be provided on the downstream side of the liquid applying device 201 and on the upstream side of the powder applying device 202.

Further, the material layer forming apparatus 2 may further include heating means for heating the base material 11 having the positive electrode active material applied by the powder applying device 202. As a heating system of the heating means, a contact-type heat roller may be used, or a non-contact-type system of irradiating infrared rays or microwaves may be adopted. In addition, heating can be performed by scanning laser light or other energy rays. The heating means may be provided on a back surface side of a belt 224 included in the belt device 22, or may be provided on a front surface side (side on which the base material 11 is carried) of the belt 224.

In order to densely arrange the particles on the base material, it is preferred that the liquid be applied to the entire surface of the base material, and the second particles P2 be arranged in a region in which the first particles P1 are not arranged through use of a second filling device 24. Further, similarly to the material layer forming apparatus 1, it is preferred that the material layer forming apparatus 2 include a transfer portion. The first particles P1 can be transferred from the base material 11 onto another base material including a pressure-sensitive adhesive layer, and the second particles P2 can be arranged in the region in which the first particles P1 are not arranged in the base material having the first particles P1 transferred thereon through use of the second filling device 24. In this manner, the particles can be densely arranged on the base material.

In the material layer forming apparatus 1 and 2, the coverage of the base material by the active material is preferably 60% or more, more preferably 70% or more, further preferably 80% or more. The coverage of the base material by the active material can be measured by imaging, by an optical microscope, the region in which the material layer is formed in a direction vertical to the base material, and calculating an area percentage of the positive electrode active material in the region by image processing software.

When the coverage of the base material by the active material is increased as described above, an active material including protruding portions protruding in a plurality of directions is more likely to be produced. The reason therefor is assumed to be as follows. When the sintering treatment is performed in the third step to be described later, the base material is gasified. It is considered that, as the active material is more likely to be in contact with the gas, the protruding portions are more likely to be protruding from the active material. When the coverage of the base material by the active material is high, the active materials are densely arranged, and a void between the active material and the active material is decreased in size. Thus, the active material is more likely to be in contact with the gas. Meanwhile, when the coverage of the base material by the active material is low, the active materials are coarsely arranged, and the void between the active material and the active material is increased in size. Thus, the active material is less likely to be in contact with the gas.

(Second Step)

The second step is a step of laminating a plurality of material layers to form a laminated body. It is preferred that the laminated body include three or more laminated material layers.

FIG. 11 is a view for schematically illustrating a configuration of a laminated body forming apparatus. The laminated body forming apparatus includes a conveying device 31 which conveys the base material 11 having the material layer 12 formed thereon, and a stage 32 capable of performing relative movement in a perpendicular direction by an actuator (not shown).

The conveying device 31 receives the base material 11 including the material layer 12 formed through use of the material layer forming apparatus, and conveys the base material 11 to the stage 32. As the conveying device 31 capable of conveying the base material 11, for example, a belt conveyor, a roller, or a robot arm can be given.

When the base material 11 is conveyed to the stage 32 by the conveying device 31, the stage 32 is moved in the perpendicular direction by an amount corresponding to the thicknesses of the base material 11 and the material layer 12. With repetition of conveyance by the conveying device 31 and movement of the stage 32, a plurality of base materials 11 each having the material layer 12 formed thereon are laminated so that a laminated body 13 is formed.

It is preferred that a charge eliminating step of subjecting the base material to charge elimination be performed between the first step and the second step. In the first step, the base material and the particles on the base material are liable to be charged, and an electrostatic repulsive force is generated between the base material and the base material when the base materials are laminated. Accordingly, when the base materials are laminated in the second step, the base material may be peeled off, or an air gap is liable to be generated between the base material and the base material. In this manner, it is considered that the active material is less likely to be in contact with the gas, and the protruding portions are less likely to be protruding from the active material. In the charge eliminating step, it is preferred that the charge elimination be performed in a non-contact manner by, for example, a static electricity elimination blower.

(Third Step)

The third step is a step of subjecting the laminated body to sintering treatment to produce the positive electrode active material.

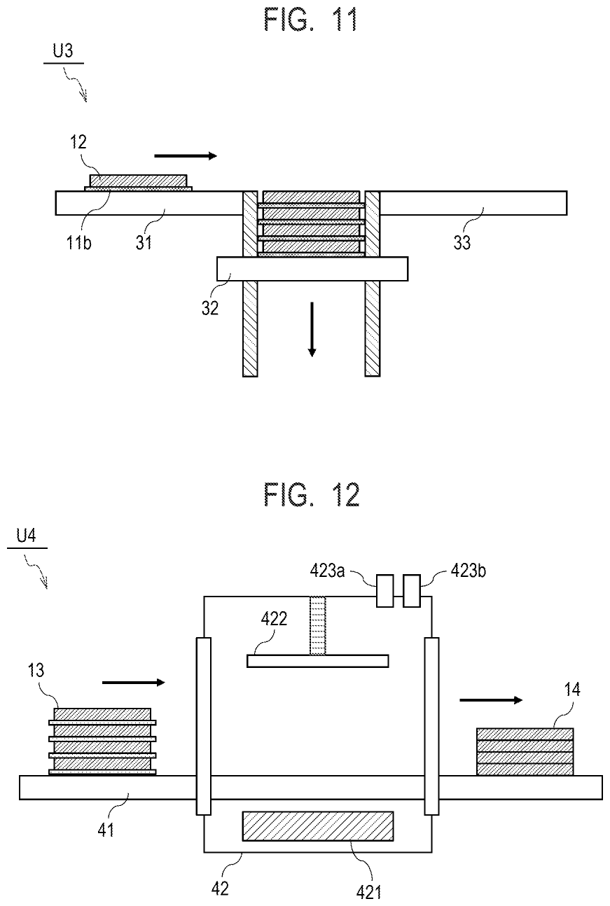

FIG. 12 is a view for schematically illustrating a configuration of a sintering treatment apparatus. The sintering treatment apparatus includes a conveying device 41 which conveys the laminated body 13, and a heating furnace 42 which heats the laminated body 13.

The conveying device 41 receives the laminated body 13 from the laminated body forming apparatus, and conveys the laminated body 13 to the heating furnace 42. It is preferred that, similarly to the conveying device 31, the conveying device 41 be a device capable of conveying the laminated body 13. As the device capable of conveying the laminated body 13, for example, a belt conveyor, a roller, or a robot arm can be given.

The heating furnace 42 is a furnace which heats the laminated body 13. The heating furnace 42 includes heating means 421, pressure applying means 422, and atmosphere adjusting means 423. As the heating furnace 42, a firing furnace to be used to fire ceramics and the like can be used. The pressure applying means 422 applies pressure to the laminated body 13 being heated in the heating furnace 42, or applies pressure to the laminated body 13 before or after the heating. In the pressure applying means 422, it is preferred that a pressure applying portion which applies pressure to the laminated body 13 be formed of a porous body capable of easily passing gas therethrough. The atmosphere adjusting means 423 includes atmospheric gas supplying means 423a and decompressing means 423b, and adjusts an atmospheric gas in a treatment space of the heating furnace 42.

When the laminated body is subjected to sintering treatment, it is preferred that the laminated body be heated at a temperature equal to or higher than a thermal decomposition temperature of the base material 11 in the laminated body 13, and it is preferred that the laminated body be heated at a temperature lower than a thermal decomposition temperature of each material layer in the laminated body 13. The temperature to heat the laminated body is preferably 300° C. or more and 1,000° C. or less, more preferably 400° C. or more and 800° C. or less. When the laminated body 13 includes a plurality of types of base materials 11 made of different materials, the heating temperature may be set to a temperature equal to or higher than the highest thermal decomposition temperature among the thermal decomposition temperatures of the plurality of base materials.

In this manner, the base material in the laminated body is selectively decomposed to remove the base material, thereby being capable of producing the positive electrode active material including the protruding portions protruding in the plurality of directions. In this case, in the laminated body before the heating, the positive electrode active material does not include the protruding portions protruding in the plurality of directions. During the heating process, the positive electrode active material includes the protruding portions protruding in the plurality of directions.

The thermal decomposition temperature refers to a temperature at which the material begins to reduce weight when the temperature is gradually increased in the atmosphere at the time of the heating in the sintering treatment apparatus. Thus, when the laminated body is heated at a temperature equal to or higher than the thermal decomposition temperature of the base material 11, the base material 11 in the laminated body can be decomposed so as to reduce the weight of the laminated body, and the base material 11 can be removed from the laminated body. It is preferred that the heating temperature be a temperature equal to or higher than the thermal decomposition temperature of the base material 11, and it is preferred that the heating be performed at a temperature further higher than the thermal decomposition temperature. Specifically, it is preferred that the heating be performed at a temperature equal to or higher than a temperature at which the weight becomes 70% of an initial weight when thermogravimetric analysis is performed while the temperature is increased from room temperature (25° C.) at a rate of 5° C./min in an atmosphere (typically, air) at the time of the heating in the sintering treatment apparatus. Further, it is more preferred that the heating be performed at a temperature equal to or higher than a temperature at which the weight becomes 50% of the initial weight when thermogravimetric analysis is performed in the same manner, and it is further preferred that the heating be performed at a temperature equal to or higher than a temperature at which the weight becomes 20% of the initial weight. In this manner, the time required for removing the base material 11 can be reduced, and the removal rate of the base material 11 can be increased.

That is, when the sintering treatment apparatus removes the base material 11 by heating, it is preferred that the positive electrode active material be a material having a thermal decomposition temperature higher than that of the base material 11. In general, an inorganic material tends to have a thermal decomposition temperature higher than that of an organic material. Accordingly, it is preferred that the positive electrode active material be an inorganic material, and that the material of the base material 11 be an organic material, for example, a resin. Further, when the sintering treatment apparatus removes the base material 11 by heating, it is preferred that the positive electrode active material be a material having a softening point temperature higher than the thermal decomposition temperature of the base material 11.

The sintering treatment apparatus preferably eliminates 90% by weight or more of the base materials in the laminated body 13 by heating, more preferably eliminates 95% by weight or more of the base materials in the laminated body 13, further preferably eliminates 97% by weight or more of the base materials in the laminated body 13. At this time, it is preferred that the base materials be burnt or gasified to be discharged as gas to the outside.

In order to form the protruding portions from the positive electrode active material in the plurality of directions, when the base material is gasified, it is required that the gas be uniformly brought into contact with the positive electrode active material. For this purpose, it is preferred that the positive electrode active material be densely arranged on the base material, and that the thickness of the base material be reduced so that the density between the particles in the laminating direction of the base materials is increased. Specifically, the thickness (μm) of the base material is preferably 10 times or less of the particle diameter (μm) of the positive electrode active material, more preferably 5 times or less thereof, further preferably 2 times or less thereof. In this case, the thickness of the base material in a case in which the base material has the pressure-sensitive adhesive layer on its surface refers to a total thickness of the thickness of the pressure-sensitive adhesive layer and the thickness of the base material. Further, the particle diameter of the positive electrode active material refers to a volume-based cumulative 50% particle diameter (median diameter). The thickness of the base material can be measured through use of a digital thickness gauge or the like. The thickness of the pressure-sensitive adhesive layer can be measured by removing the pressure-sensitive adhesive layer on the base material with a solvent, and measuring the base material by the digital thickness gauge so as to measure a difference. The particle diameter of the positive electrode active material can be measured through use of a laser diffraction/scattering particle size distribution analyzer (LA-960, manufactured by Horiba, Ltd.).

It is preferred that the thickness of the base material be 1 μm or more and 1 mm or less. It is preferred that the particle diameter of the positive electrode active material be 0.1 μm or more and 100 μm or less.

Through use of a base material made of an organic material, for example, a resin, as the base material, removal of the base material by the heating can be facilitated. As a material for forming the base material, polyethylene (PE), polypropylene (PP), polyesters, such as polyethylene terephthalate (PET), and polyamides, such as nylon, may be used. Of those, PET is preferably used from the viewpoints of a decomposition temperature and low-hazardousness of gas generated at the time of thermal decomposition.

It is preferred that the sintering treatment apparatus exhaust released gas to the outside of the heating furnace 42 by the decompressing means 423b. When the inside of the heating furnace 42 is kept to an oxidizing atmosphere, that is, an atmosphere containing an oxide gas, for example, air, by using the atmospheric gas supplying means 423a or the like, the base material can be removed by burning.

When the base materials are gasified from the laminated body 13 by thermal decomposition and are released as gas, each material layer in the laminated body 13 may be pushed up to change its shape. Accordingly, when heating is performed in the heating furnace 42, the laminated body 13 may be applied with pressure by the pressure applying means 422 before or after the heating, during the heating, or during cooling or heat radiation after the heating. Further, after the base materials are removed by the sintering treatment apparatus, a pressure applying device (for example, an isostatic pressing device) may separately perform pressure application, and the heating may be performed again by the sintering treatment apparatus.

It is preferred that a pressure applying step of applying pressure to the laminated body be performed between the second step and the third step. It is preferred that the pressure application be performed at from 5 MPa to 500 MPa. The particles on each base material to be laminated body are brought into a uniform state, and the formation of the protruding portions is stabilized. It is preferred that the specific pressure applying step be performed through vacuum degassing or isostatic pressing, or through use of a general hydraulic press machine or roller pressing machine. Of those, it is preferred that the pressure application be performed through combination of vacuum degassing and isostatic pressing. When the isostatic pressing is performed under a state in which air between the base material and the base material forming the laminated body is removed, the void between the active material and the active material is decreased in size. Thus, the active material is likely to be in contact with the gas, and the protruding portions are likely to be protruding from the active material. Further, the active materials are densely arranged, and thus the protruding portions are protruding from a large number of active materials. Thus, the active material including the protruding protruding portions can be obtained at a high yield.

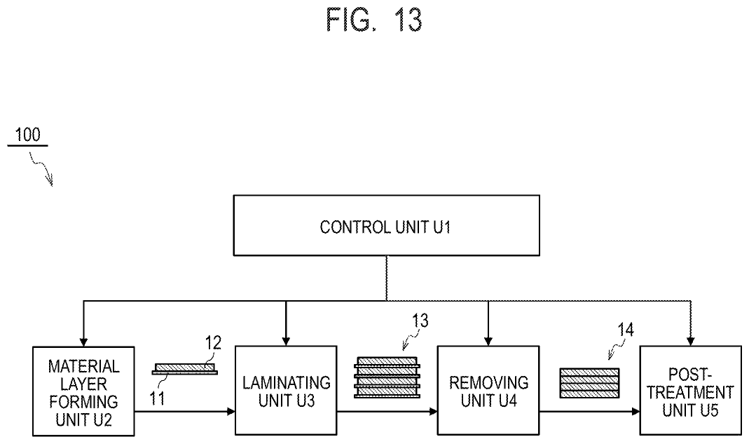

FIG. 13 is a view for schematically illustrating an overall configuration of an additive manufacturing system. An additive manufacturing system 100 includes a control unit U1, a material layer forming unit U2, a laminating unit U3, a removing unit U4, and a post-treatment unit U5. The control unit U1 performs control and the like of each unit of the additive manufacturing system 100. The material layer forming unit U2 forms, through use of the above-mentioned material layer forming apparatus (FIG. 2), the material layer 12 on the base material 11. The laminating unit U3 laminates, through use of the above-mentioned laminated body forming apparatus (FIG. 11), the plurality of base materials 11 each having the material layer 12 formed by the material layer forming unit U2, to thereby form the laminated body 13 including the plurality of material layers 12 and the plurality of base materials 11. The removing unit U4 removes, through use of the above-mentioned sintering treatment apparatus (FIG. 12), the base materials 11 from the laminated body 13 formed by the laminating unit U3, to thereby form a three-dimensional object 14. The three-dimensional object 14 includes the positive electrode active material including the protruding portions protruding in the plurality of directions. The post-treatment unit U5 performs post-treatment of the three-dimensional object 14 formed by the removing unit U4. The unit configuration illustrated in FIG. 13 is merely an example, and other configurations may be adopted. The configuration and the operation of each unit are described below.

[Control Unit]

The control unit U1 performs control and the like of each unit of the additive manufacturing system 100, specifically, the material layer forming unit U2, the laminating unit U3, the removing unit U4, and the post-treatment unit U5.

The control unit U1 may include a three-dimensional shape data input portion which receives, from an external apparatus (for example, a personal computer), input of three-dimensional shape data of a three-dimensional object (hereinafter also referred to as “manufacturing object”) to be formed by the additive manufacturing system 100. As the three-dimensional shape data, data created and output by a three-dimensional CAD, a three-dimensional modeler, a three-dimensional scanner, or the like can be used. A file format thereof is not particularly limited. For example, it is preferred that a stereolithography (STL) file format be used.

The control unit U1 may include a slice data calculation portion which calculates a cross-sectional shape of each layer by slicing the three-dimensional shape data at a predetermined pitch, and generates, based on the cross-sectional shape, image data (referred to as “slice data”) to be used for image formation in the material layer forming unit U2. Further, the slice data calculation portion may analyze the three-dimensional shape data or the slice data of upper and lower layers so as to determine presence or absence of an overhanging portion (suspended portion), and, as required, add an image for a support material to the slice data.

As described in detail later, the material layer forming unit U2 in this embodiment can form a material layer in which a plurality of types of materials are used and each material is patterned. Accordingly, as the slice data, data corresponding to the image of each material may be generated. As a file format of the slice data, for example, multivalued image data (each value represents the type of the material) or multiplane image data (each plane corresponds to the type of the material) can be used.

Further, although not shown, the control unit U1 also includes an operation portion, a display portion, and a storage portion. The operation portion corresponds to a function of receiving instructions from a user. For example, on/off of a power supply, various settings of devices, instructions of operations, and the like can be input. The display portion corresponds to a function of presenting information to the user. For example, various setting screens, error messages, operation statuses, and the like can be presented. The storage portion corresponds to a function of storing the three-dimensional shape data, the slice data, various setting values, and the like.

The control unit U1 can be implemented in the form of hardware by a computer including a central processing unit (CPU), a memory, an auxiliary storage device (hard disk drive, flash memory, and the like), an input device, a display device, and various types of I/F. Each of the above-mentioned functions is implemented by the CPU reading and executing a program stored in the auxiliary storage device and the like and controlling a required device. However, a part or all of the above-mentioned functions may be formed of circuits such as an ASIC and an FPGA, or may be implemented by other computers through use of a technology of cloud computing, grid computing, or the like.

[Material Layer Forming Unit]

The material layer forming unit U2 is a unit which forms the material layer 12 on the base material 11. As the material layer forming unit U2, the above-mentioned material layer forming apparatus 2 can be used.

The additive manufacturing system 100 may include a plurality of material layer forming units U2. In this manner, formation of the material layers 12 on the respective base materials 11 can be simultaneously performed in parallel, and the throughput of formation of the laminated body and the three-dimensional object can be further improved. Further, for example, when the three-dimensional object is formed of a large number of types of materials, switching of the material types and switching of the processes in the material layer forming unit U2 can be omitted by providing the material layer forming unit U2 for each material type or each group of material types. In this manner, the three-dimensional object can be produced continuously.

[Laminating Unit]

The laminating unit U3 is a unit which laminates the plurality of base materials 11 each having the material layer 12 formed by the material layer forming unit U2, to thereby form the laminated body 13 including the plurality of material layers 12 and the plurality of base materials 11. The above-mentioned laminated body forming apparatus can be used.

The laminating unit U3 may further include a conveying device 33 which conveys the formed laminated body 13 to the removing unit U4 or the like, and a pressure applying device (not shown) which applies pressure to the laminated body 13 in the laminating direction. The conveying device 33 may have a configuration similar to that of the conveying device 31.

[Removing Unit]

The removing unit U4 is a unit which removes the base materials 11 from the laminated body 13 formed by the laminating unit U3, to thereby form the three-dimensional object 14. The above-mentioned sintering treatment apparatus can be used.

[Post-Treatment Unit]

The post-treatment unit U5 is a unit which performs post-treatment of the three-dimensional object 14 formed by the removing unit U4.

The type of the post-treatment to be performed by the post-treatment unit U5 is not particularly limited. For example, treatment of further heating and firing the three-dimensional object 14 can be given. When the post-treatment unit U5 performs heating treatment as the post-treatment, the removing unit U4 may also serve to have the function of the post-treatment unit U5. Firing of the three-dimensional object 14 enables the materials such as particle materials in each material layer to be sintered with each other.

Similarly to the removing unit U4, the post-treatment unit U5 may include pressure applying means for pressurizing the three-dimensional object 14. Similarly to the removing unit U4, the post-treatment unit U5 may apply pressure to the three-dimensional object 14 by the pressure applying means before the heating performed as the post-treatment, during the heating, or during cooling or heat radiation after the heating.

<Electrode>

An electrode includes an active material and an electrolyte, and the active material includes protruding portions protruding in a plurality of directions. It is preferred that the active material be produced through use of the above-mentioned production method. Further, the electrode can be produced by a method similar to the above-mentioned method of producing an active material, except that the first particles are changed to the active material and the second particles are changed to the electrolyte. The active material included in the obtained electrode includes the protruding portions protruding in the plurality of directions.

(Electrolyte)

Examples of the electrolyte include a solid electrolyte and a liquid electrolyte.

[Solid Electrolyte]

Examples of the solid electrolyte include an oxide-based solid electrolyte, a sulfide-based solid electrolyte, and a complex hydride-based solid electrolyte. Examples of the oxide-based solid electrolyte include NASICON-type compounds, such as Li_{1.5}Al_{0.5}Ge_{1.5}(PO₄)₃ and Li_{1.3}Al_{0.3}Ti_{1.7}(PO₄)₃, and garnet-type compounds, such as Li_{6.25}La₃Zr₂Al_{0.25}O₁₂. Further examples of the oxide-based solid electrolyte include perovskite-type compounds, such as Li_{0.33}Li_{0.55}TiO₃. Further examples of the oxide-based solid electrolyte include LISICON-type compounds, such as Li_{1.4}Zn(GeO₄)₄, and acid compounds, such as Li₃PO₄, Li₄SiO₄, and Li₃BO₃. Specific examples of the sulfide-based solid electrolyte include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. Further, the solid electrolyte may be crystalline, amorphous, or glass ceramics. The description “Li₂S—P₂S₅” or the like means a sulfide-based solid electrolyte obtained by using a raw material containing Li₂S and P₂S₅.

[Liquid Electrolyte]

An example of the liquid electrolyte is a non-aqueous electrolytic solution. The non-aqueous electrolytic solution is a liquid obtained by dissolving about 1 mol of a lithium salt to a non-aqueous solvent. Examples of the non-aqueous solvent include ethylene carbonate, propylene carbonate, dimethyl carbonate, diethyl carbonate, and ethyl methyl carbonate. Examples of the lithium salt include LiPF₆, LiBF₄, and LiClO₄. Further, the liquid electrolyte may also be an aqueous electrolytic solution using an aqueous solvent.

<Battery>

A battery includes a positive electrode active material, a negative electrode active material, and an electrolyte, and the positive electrode active material includes protruding portions protruding in a plurality of directions. It is preferred that the positive electrode active material be produced through use of the above-mentioned production method. As the electrolyte, the above-mentioned solid electrolyte or liquid electrolyte can be given.

(Negative Electrode Active Material)

Examples of the negative electrode active material include a metal, a metal fiber, a carbon material, an oxide, a nitride, silicon, a silicon compound, tin, a tin compound, and various alloy materials. Of those, an oxide, a carbon material, silicon, a silicon compound, tin, a tin compound, and the like are preferred from the viewpoint of a volume density. An example of the oxide is Li₄Ti₅O₁₂ (LTO: lithium titanate). Examples of the carbon material include various natural graphites, coke, graphitizing carbon, a carbon fiber, spherical carbon, various artificial graphites, and amorphous carbon. Examples of the silicon compound include a silicon-containing alloy, a silicon-containing inorganic compound, a silicon-containing organic compound, and a solid solution. Examples of the tin compound include SnO_{b} (0<b<2), SnO₂, SnSiO₃, Ni₂Sn₄, and Mg₂Sn. Further, the negative electrode materials may contain a conductive assistant. Examples of the conductive assistant include graphites, such as natural graphites and artificial graphites, and carbon blacks, such as acetylene black, ketjen black, channel black, furnace black, lamp black, and thermal black. Other examples of the conductive assistant include: conductive fibers, such as a carbon fiber, a carbon nanotube, and a metal fiber; metal powders, such as carbon fluoride and aluminum; conductive whiskers, such as zinc oxide; conductive metal oxides, such as titanium oxide; and organic conductive materials, such as a phenylene derivative.

### EXAMPLES

In Examples, as the active material, lithium cobalt oxide being a positive electrode active material is used, but even when other active materials are used, the active material including the protruding protruding portions can be produced by optimizing the base materials and heating conditions in a similar process.

Lithium cobalt oxide, lithium borate, and Li_{1.5}Al_{0.5}Ge_{1.5}(PO₄)₃ are hereinafter abbreviated as LCO, LBO, and LAGP, respectively.

[Production of Positive Electrode Active Material]

### Example 1

Through use of the above-mentioned additive manufacturing system 100, a positive electrode active material was produced. Specifically, in the material layer forming unit U2, the material layer forming apparatus 1 illustrated in FIG. 2 was used. The positive electrode active material was produced by forming a material layer on a base material, and heating a laminated body obtained by laminating the base materials each having the material layer formed thereon, thereby removing the base materials.

As the first base material 11a, a sheet made of polyethylene terephthalate (PET) was used. On the first base material 11a, an uneven pattern having a lens array shape was formed by the pattern forming device 23. The lens array shape corresponded to a state in which lenses each having a depth of 5.5 μm were arrayed at a period of 7.5 μm.

First, the first base material 11a was coated with a UV-curable resin (UV-curable liquid silicone rubber, (PDMS), produced by Shin-Etsu Chemical Co., Ltd.). After that, a film mold (standard mold, produced by Soken Chemical & Engineering Co., Ltd.) having, on its surface, a lens-array-shaped protruding pattern corresponding to the uneven pattern desired to be formed was pressed against the UV-curable resin on the first base material 11a. Under a state in which the film mold was pressed, the UV-curable resin was cured by being irradiated with ultraviolet rays by a UV lamp, and the film mold was peeled off.

As the second base material 11b, there was used a sheet made of polyethylene terephthalate (PET) whose front surface (surface on which the material layer was to be formed) and back surface (surface on which the material layer was not to be formed) were coated with an acrylic pressure-sensitive adhesive. The thickness of the sheet made of PET was 20 and the thickness of the acrylic pressure-sensitive adhesive applied to the surface of the sheet made of PET was 1 μm.

As the first particles and the second particles, LCO (CELLSEED, C-5H, produced by Nippon Chemical Industrial Co., Ltd.) was used. The volume-based cumulative 50% particle diameter (median diameter) of the LCO was 7 and the median diameter was measured through use of a laser diffraction/scattering particle size distribution analyzer (LA-960, manufactured by Horiba, Ltd.). Further, as the carrying materials S1 and the carrying materials S2, standard carriers being magnetic particles (standard carrier P02, produced by The Imaging Society of Japan) were used. In this manner, the material layer 1 was formed. When the material layer 1 was formed, the proportion of the positive electrode active material in each of the fillers 241a and 241b was set to 17% by weight.

In the material layer 1, a substantially single layer of LCO was formed on the base material, and the coverage of the base material by the LCO was 80%. The coverage of the base material by the LCO was measured by imaging, by an optical microscope, the region in which the material layer was formed in the direction vertical to the base material, and calculating an area percentage of the positive electrode active material in the region by image processing software (Photoshop (trademark) produced by Adobe Systems Co., Ltd.). The LCO on the base material was uniformly arranged in the base material laminating direction within the base material surface, and hence degree of protrusion (uneven distribution of direction and variation of length) of the protruding portions protruding from the positive electrode active material became better. After the material layer was formed on the base material, the base material was subjected to charge elimination by a static electricity elimination blower (manufactured by AS ONE Corporation).

Next, in the laminating unit U3, three second base materials 11b each having the material layer formed thereon were laminated on an aluminum foil (having a thickness of 20 μm). After that, the aluminum foil having the second base materials 11b laminated thereon was put into a lamination film (produced by Asahi Kasei Pax Corporation). This film was subjected to vacuum lamination by a vacuum packaging machine (manufactured by Tosei Corporation), and was applied with pressure of 200 MPa by an isostatic pressing device (manufactured by Nikkiso Co., Ltd.). In this manner, there was obtained a laminated body in which three second base materials 11b each having the material layer formed thereon were laminated on the aluminum foil.

Next, in the removing unit U4, the base materials were removed from the laminated body by heating. As the removing unit U4, an electric furnace (desktop muffle furnace, manufactured by Yamada Denki Co., Ltd.) was used. The laminated body was placed on a ceramic stage in the electric furnace, and was heated under atmosphere without applying pressure. Through use of a heating profile, the temperature was raised from room temperature (25° C.) to 250° C. at a rate of 2.5° C. per minute. Further, the temperature was raised from 250° C. to 510° C. at a rate of 0.5° C. per minute. After reaching 510° C., the temperature was maintained for 1 hour, and then cooling was performed until the temperature reaches room temperature (25° C.).

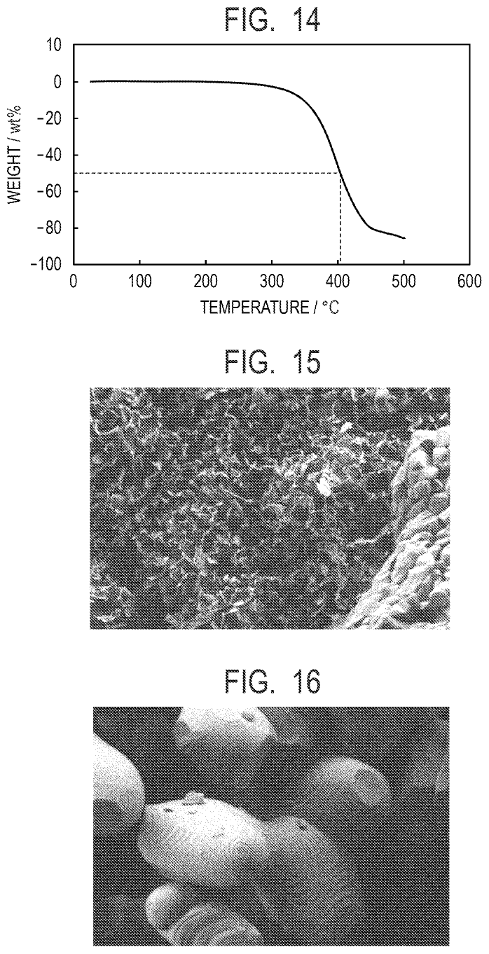

FIG. 14 is a graph for showing results of thermogravimetric analysis of PET coated with an acrylic pressure-sensitive adhesive, which corresponds to the second base material 11b. The thermogravimetric analysis was performed through use of a thermogravimetric-differential thermal analyzer (TG-DTA, manufactured by Rigaku Corporation) by increasing the temperature from room temperature (25° C.) at a rate of 5° C. per minute in atmosphere. As shown in FIG. 14, the temperature at which the weight became 50% of the initial weight was about 400° C., and the temperature at which the weight became 20% of the initial weight was about 500° C. That is, the results show that, when the base material is heated at a temperature exceeding about 500° C., a large part of the base material can be removed. Further, the thermal decomposition temperature of the LCO was 510° C. or more.

FIG. 15 is an image obtained by imaging, by an electron microscope, a laminated body obtained after the base materials are removed. FIG. 16 is an image obtained by imaging, by the electron microscope, LCO heated under conditions similar to those in the above-mentioned heating profile. As shown in FIG. 16, the LCO was solely heated, but the LCO did not have protruding portions. Meanwhile, as in Example 1, when the LCO was arranged on the base material, and a plurality of base materials were laminated, the LCO subjected to heating removal had the protruding portions.

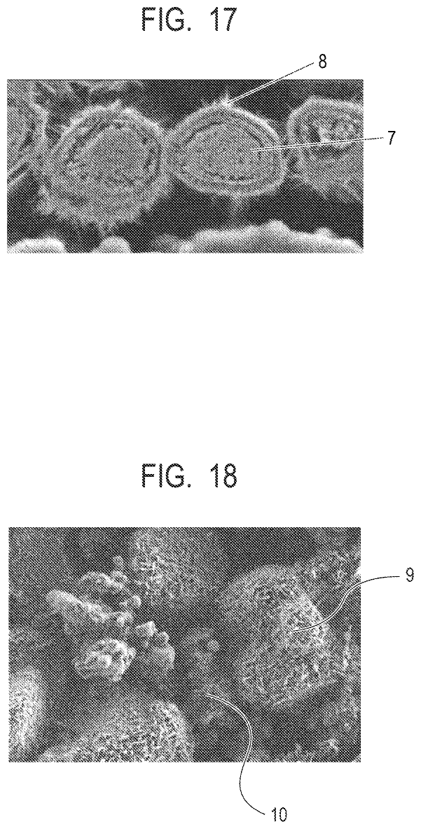

FIG. 17 is an image obtained by imaging, by the electron microscope, a cross section of the laminated body obtained after the base materials are removed. A cross-section sample was produced through use of an ion milling device (manufactured by Leica Microsystems). A plurality of protruding portions 8 were protruding on a surface of a core portion 7 of the LCO. In order to examine the composition of the protruding portion 8, there was performed energy dispersive X-ray spectroscopy (EDX) by a scanning electron microscope (SEM) or a transmission electron microscope (TEM). As a result, it was recognized that the protruding portion had peaks of Co and O in the same manner as the core portion. Further, when a sample piece obtained by curing, with a resin, the laminated body obtained after the base materials were removed and slicing the laminated body by FIB was observed through use of a cross-sectional TEM, there was recognized a lattice texture corresponding to a crystal structure in both of the core portion and the protruding portion. As described above, the positive electrode active material including the protruding portions protruding in the plurality of directions was able to be produced.

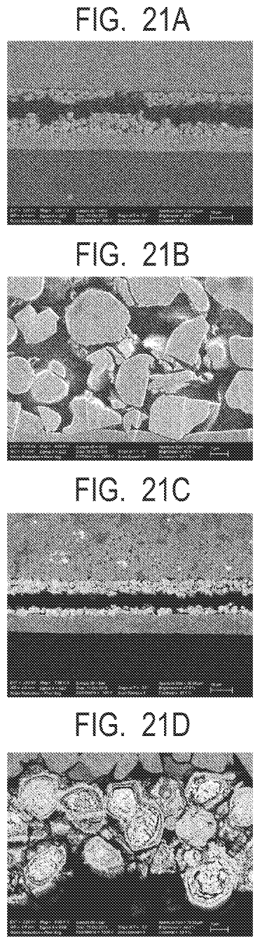

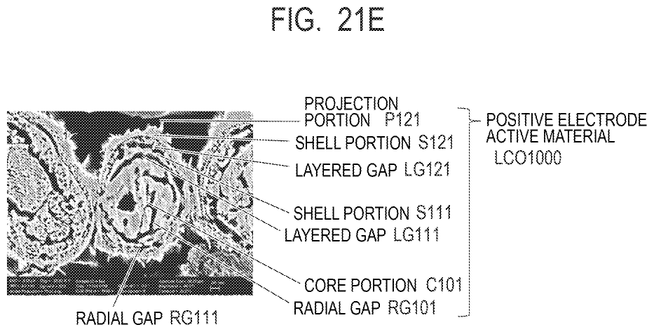

Further, cross sections of the laminates obtained before a heating step of removing the base materials was performed (FIG. 21A and FIG. 21B) and after the heating step was performed (FIG. 21C, FIG. 21D, and FIG. 21E) were each observed through use of the scanning electron microscope (SEM). As a result, in the cross section of the laminated body obtained after the heating step of removing the base materials was performed, a specific cross-section profile was recognized. This specific cross-section profile included the following features. That is, <discontinuity inside of particle>, <core-shell-like gap structure 1>, <gap structure 2 of core itself and shell itself, <protruding portions recognized on outermost peripheral shell>, and <dense region and porous region which are recognized in each of core and shell> were included.

<Discontinuity Inside of Particle>

It is found that a cross section of a particulate LCO seen in an SEM image of FIG. 21B has a plane texture, but a cross section of a particulate LCO seen in an SEM image of FIG. 21D and FIG. 21E has a discontinuous texture inside of the particle.

<Core-Shell-Like Gap Structure 1>

It is recognized that the cross section of the particulate LCO present in the SEM image of FIG. 21B shows a form of an aggregate of particles, but the cross section of the particulate LCO present in the SEM image of FIG. 21D and FIG. 21E has a core-shell structure including a core portion C101 and a plurality of layered shell portions S111 and S121. That is, in the cross section of the particulate LCO present in the SEM image of FIG. 21D and FIG. 21E, a plurality of layered gaps LG111 and LG121 are recognized along the respective shell portions. In other words, the particle portion of the positive electrode active material LCO includes the core portion C101, the shell portions S111 and S121, and the layered gaps LG111 and LG121 located between the core portion and the shell portions. In other words, in the particle portion of the positive electrode active material LCO, the plurality of shell portions S111 and S121 are present in a radial direction of the core portion C101, and the plurality of layered gaps LG111 and LG121 are present in the radial direction of the core portion C101.

<Gap Structure 2 of Core Itself and Shell Itself

It is recognized that the cross section of the particulate LCO present in the SEM image of FIG. 21B shows a form of an aggregate of plain particles as described above, but the cross section of the particulate LCO present in the SEM image of FIG. 21D and FIG. 21E has radial gaps RG101 and RG111 extending in the direction of the core portion C101 and the shell portions S111 and S121. The particle portion of the positive electrode active material LCO includes the radial gaps RG101 and RG111. In other words, the particle portion of the positive electrode active material LCO further includes a core portion and a shell portion, and the radial gap is present in at least the shell portion S111.

<Protruding Portions Recognized on Outermost Peripheral Shell>

It is recognized from FIG. 21E that protruding portions P121 protruding to the outer side are present on the outer side of the outermost peripheral shell portion S121. It is considered that the protruding portions P121 increase a contact probability between particulate positive electrode active materials LCO1000, or between the particulate positive electrode active material LCO1000 and an electrolyte (not shown).

It is found that the cross section of the LCO particle included in the laminated body obtained after the above-mentioned heating step is performed is obviously increased in specific surface area, including not only the outer peripheral surface but also the internal structure of the particle, as compared to the LCO particle included in the laminated body obtained before the heating step is performed. The particle portion of the positive electrode active material LCO includes the core portion C101 and the shell portions S111 and S121, and the protruding portions P121 protrude from at least the shell portion S121. There is also recognized a positive electrode active material LCO having protruding portions protruding from each of the shell portion and the core portion.

<Dense Region and Porous Region which are Recognized in Each of Core and Shell>

Such an increase in specific surface area is assumed to be achieved through consumption of a part of dense particles before the heating during radial growth of the shell portion and the core portion, crack formation, and growth of the protruding portions (whiskers). It is considered that, in the core portion and the shell portion, a porous region is formed through formation of two types of gap structures, an increase in diameter of the core portion and the shell portion, and generation of the protruding portions. Similarly, it is recognized that the protruding portions are generated both inward and outward in the radial direction of the core portion and the shell portion. It is considered that a part which has not been consumed by the formation of the two types of gap structures, the increase in diameter of the core portion and the shell portion, and the generation of the protruding portions remains as a dense region extending in a circumferential direction. Further, it is considered that the growth of the protruding portions (whiskers) exhibits, like frost columns, an effect of accelerating an action of forming a gap for separating the core portion and the shell portion away from each other. Further, it is considered that an action of enlarging the diameter of the core-shell structure is achieved by generating cracks in a metal oxide crystal having a low modulus of elasticity. Further, it is considered that the generated cracks exhibit an effect of introducing oxygen contained in the firing atmosphere and gas having a catalysis action into the layered gaps inside of the particles.

### Example 2

As the second base material 11b, an acrylic resin (having a film thickness of 20 μm) having a pressure-sensitive adhesive property was used. The coverage of the base material by the LCO was 80%. Other conditions were similar to those of Example 1, and the positive electrode active material was produced under those conditions. As a result, similarly to Example 1, a positive electrode active material including protruding portions protruding in a plurality of directions was able to be produced.

### Example 3

An uneven pattern having a lens array shape was formed on the first base material 11a. Unlike Example 1, the lens array shape corresponded to a state in which lenses each having a depth of 5.0 μm were arrayed at a period of 12.0 μm. Further, unlike Example 1, the second particles (LCO) were not used, and only the first particles were arranged on the base material 11a. The coverage of the base material by the LCO was 60%. Other conditions were similar to those of Example 1, and the positive electrode active material was produced under those conditions. As a result, similarly to Example 1, a positive electrode active material including protruding portions protruding in a plurality of directions was able to be produced.

### Comparative Example 1

In the laminating unit U3, one base material 11b having the material layer formed thereon was caused to adhere onto an aluminum foil (having a thickness of 20 μm). The coverage of the base material by the LCO was 80%. The positive electrode active material was produced under conditions similar to those of Example 1, except that the number of laminated base materials was changed to 1. As a result, a positive electrode active material including protruding portions protruding in a plurality of directions was not able to be produced.

[Production of Positive-Pole Electrode]

### Example 4

Through use of the above-mentioned additive manufacturing system 100, a positive-pole electrode including a positive electrode active material including protruding portions protruding in a plurality of directions was produced. Specifically, in the material layer forming unit U2, the material layer forming apparatus 1 illustrated in FIG. 2 was used. The positive-pole electrode was produced by forming a material layer on a base material, and heating a laminated body obtained by laminating the base materials each having the material layer formed thereon, thereby removing the base materials.

As the first base material 11a, a sheet made of polyethylene terephthalate (PET) was used. On the first base material 11a, an uneven pattern having a lens array shape was formed by the pattern forming device 23. The lens array shape corresponded to a state in which lenses each having a depth of 5.5 μm were arrayed at a period of 7.5 μm.

As the second base material 11b, there was used a sheet made of PET whose front surface (surface on which the material layer was to be formed) and back surface (surface on which the material layer was not to be formed) were coated with an acrylic pressure-sensitive adhesive. The thickness of the sheet made of PET was 5 μm, and the thickness of the acrylic pressure-sensitive adhesive applied to the surface of the sheet made of PET was 1 μm.

As the first particles, the same LCO as that of Example 1 was used. As the second particles, LBO (produced by Toshima Manufacturing Co., Ltd.) being a solid electrolyte was used. As the carrying materials S1 and the carrying materials S2, the same magnetic particles as those of Example 1 were used. The volume-based cumulative 50% particle diameter of the LBO was 5 μm. In this manner, the material layer 1 was formed. When the material layer 1 was formed, the proportion of the LCO in the filler 241a was set to be 17% by weight, and the proportion of the LBO in the filler 241b was set to be 15% by weight.

In the material layer 1, the LCO and the LBO were arranged on the base material, and the coverage of the base material by the LCO and the LBO was 80%. After the material layer was formed on the base material, the base material was subjected to charge elimination by a static electricity elimination blower (manufactured by AS ONE Corporation).

Next, in the laminating unit U3, three base materials 11b each having the material layer formed thereon were laminated on a separately-produced solid electrolyte sheet (having a thickness of 270 μm). The solid electrolyte sheet was produced by subjecting LAGP (produced by Toshima Manufacturing Co., Ltd.) being a solid electrolyte to press forming, and sintering the sheet in an electric furnace (850° C./12 h/atmosphere). In this case, the volume-based cumulative 50% particle diameter of the LAGP was 5 μm.

After that, the solid electrolyte sheet having the base materials 11b laminated thereon was put into a lamination film (produced by Asahi Kasei Pax Corporation). This film was subjected to vacuum lamination by a vacuum packaging machine (manufactured by Tosei Corporation), and was applied with pressure of 200 MPa by an isostatic pressing device (manufactured by Nikkiso Co., Ltd.). There was obtained a laminated body in which three base materials 11b each having the material layer formed thereon were laminated on the solid electrolyte sheet.

Next, in the removing unit U4, the base materials were removed from the laminated body by heating. As the removing unit U4, an electric furnace (desktop muffle furnace, manufactured by Yamada Denki Co., Ltd.) was used. The laminated body was placed on a ceramic stage in the electric furnace, and was heated under atmosphere without applying pressure. Through use of a heating profile, the temperature was raised from room temperature (25° C.) to 250° C. at a rate of 2.5° C. per minute. Further, the temperature was raised from 250° C. to 510° C. at a rate of 0.5° C. per minute. After reaching 510° C., the temperature was maintained for 1 hour, and then cooling was performed until the temperature reaches room temperature (25° C.). That is, it is shown that, when the base material is heated at a temperature exceeding about 500° C., a large part of the base material can be removed. Further, the thermal decomposition temperatures of the LCO and the LBO were both 510° C. or more. In this manner, the positive-pole electrode including the positive electrode active material and the solid electrolyte was obtained.

FIG. 18 is an image obtained by imaging, by the electron microscope, a positive electrode surface of the positive-pole electrode. It was recognized that a gap in an LCO particle portion 9 of the positive electrode active material was filled with an LBO particle portion 10 of the electrolyte, and there were obtained LCO protruding portions 10 of the positive electrode active material, which were protruding in a plurality of directions from the LCO particle portion 9 of the positive electrode active material. In other words, the LBO particle portion 10 of the electrolyte is arranged between particle portions of the LCO particle portion 9 of the positive electrode active material.

In order to check the performance of the positive-pole electrode as the battery, the battery was assembled. As a negative electrode, an indium foil (having a thickness of 50 μm) was fixed to a back surface (side opposite to the positive electrode surface) of the solid electrolyte sheet. As a positive electrode current collector, an aluminum foil (having a thickness of 10 μm) was fixed to the corresponding electrode, and as a negative electrode current collector, a copper foil (having a thickness of 10 μm) was fixed to the corresponding electrode. A tab with a sealant was welded to the current collector. The assembly was put into an Al lamination film. The film was subjected to vacuum lamination by a vacuum packaging machine (manufactured by Tosei Corporation), and was applied with pressure by an isostatic pressing device (manufactured by Nikkiso Co., Ltd.). Thus, an all-solid-state battery including a positive-pole electrode, an electrolyte, and a negative-pole electrode was formed.

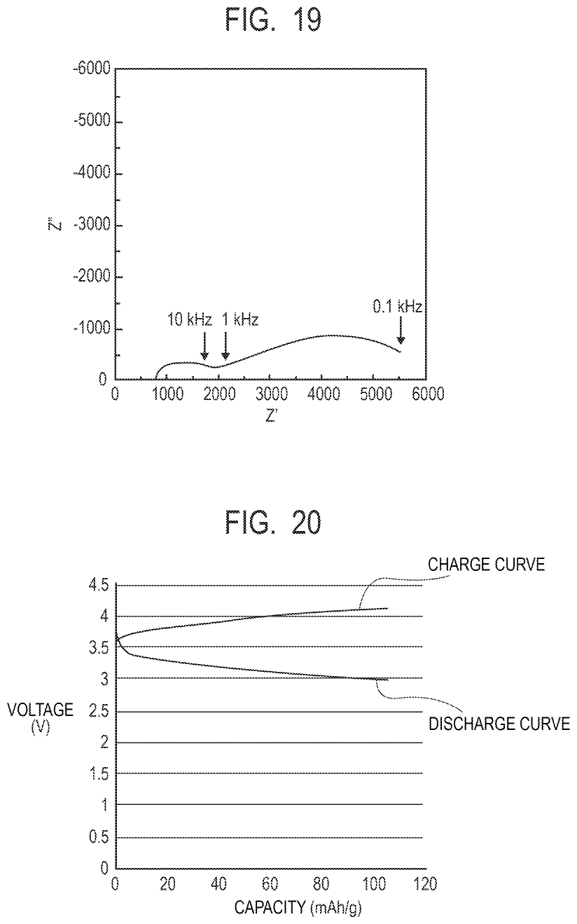

FIG. 19 shows results (Nyquist plot) of impedance measurement of the all-solid-state battery of Example 4. The horizontal axis Z′ of the Nyquist plot represents a real axis of the impedance, and the vertical axis Z″ thereof represents an imaginary axis of the impedance. The impedance measurement was performed by an electrochemical measuring device (manufactured by Solartron). There were observed a crushed semicircle of a frequency of from 1,000 kHz to 10 kHz and a crushed semicircle of a frequency of from 1 kHz to 0.1 kHz. The former semicircle corresponds to a signal of the solid electrolyte, and the latter semicircle corresponds to a resistance to which the electrode contributes (mainly an electrode resistance). In FIG. 19, regarding an electrode resistance Z (Ω), Log Z was 3. In this case, the electrode resistance Z is a value calculated from a value (Z′) of a diameter of the latter semicircle. It is shown that, as the value of the electrode resistance becomes smaller, ions can more easily move to the electrolyte.

FIG. 20 shows results of charge and discharge measurement (25° C.) of the all-solid-state battery of Example 4. The charge and discharge measurement was performed by a charge and discharge measurement system (manufactured by BioLogic). The vertical axis represents a voltage (V), and the horizontal axis represents a capacity (mAh) per weight (g) of LCO. A charge/discharge current (constant current) was set to 90 uA/cm², a charge/discharge time period was set to 2 hours, and a cutoff voltage was set to 3 V (lower limit) and 4.5 V (upper limit). At this time, the charge and discharge efficiency (percentage % of discharge capacity with respect to charge capacity) was 94%. In this case, as the method of calculating the charge and discharge efficiency, there is used a value obtained by dividing the discharge capacity at the end of the discharge curve by the charge capacity at the end of the charge curve. In FIG. 20, the charge capacity at the end of the charge curve was 107%, and the discharge capacity at the end of the discharge curve was 100%.

### Comparative Example 2

In the laminating unit U3, one base material 11b having the material layer formed thereon was caused to adhere onto a solid electrolyte sheet. The coverage of the base material by the LCO and the LBO was 80%. The positive-pole electrode including the positive electrode active material and the solid electrolyte, and the all-solid-state battery using the positive-pole electrode were produced by a method similar to that of Example 4, except that the number of laminated base materials was changed to 1.

### Example 5

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 300° C.

### Example 6

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 400° C.

### Example 7

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 600° C.

### Example 8

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 700° C.

### Example 9

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 800° C.

### Example 10

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 900° C.

### Example 11

The positive-pole electrode including the positive electrode active material and the solid electrolyte, and the all-solid-state battery using the positive-pole electrode were produced by a method similar to that of Example 4, except that the reaching temperature of 510° C. of the heating profile of the electric furnace (desktop muffle furnace, manufactured by Yamada Denki Co., Ltd.) serving as the removing unit U4 was changed to 1,000° C.

[Evaluation Method]

Protruding portions: The all-solid-state battery was disassembled after the impedance measurement and the charge and discharge measurement described below were performed, and the positive electrode was observed through use of the electron microscope to check the presence and absence of the protruding portions.
Electrode resistance: The impedance measurement of the all-solid-state battery was performed, and an order of the resistance to which the electrode (positive electrode) contributes was obtained based on the Nyquist plot.
Charge and discharge efficiency: The charge and discharge measurement of the all-solid-state battery was performed, and the charge and discharge efficiency was calculated from the obtained charge capacity and discharge capacity. The charge and discharge measurement was performed at a constant current, and the measurement was performed under the same amount of current per weight of the positive electrode active material.

The evaluation results are shown in Table 1 below. In Table 1, a value Log Z obtained by taking a common logarithm of the electrode resistance Z (Ω) is shown.

TABLE 1
Evaluation results

| | Example | Comparative | Example | Example | Example | Example | Example | Example | Example |
|---|---|---|---|---|---|---|---|---|---|
| | 4 | Example 2 | 5 | 6 | 7 | 8 | 9 | 10 | 11 |
| Presence/absence | Present | Absent | Present | Present | Present | Present | Present | Present | Present |
| of needle-like | | | | | | | | | |
| portions | | | | | | | | | |
| LogZ | 3 | 6 | 6 | 5 | 3 | 4 | 5 | 6 | 6 |
| Charge and | 94 | 0 | 0 | 30 | 92 | 80 | 40 | 0 | 0 |
| discharge | | | | | | | | | |
| efficiency (%) | | | | | | | | | |

In Comparative Example 2 in which the positive electrode active material did not include the protruding portions, the electrode resistance was high, and charging and discharging were not detected. Meanwhile, in Examples 4, 6 to 9 in which the positive electrode active material included the protruding portions and the base materials were sufficiently removed, the charging and discharging were detected regardless of a high rate (corresponding to 0.5C). The reason is considered to be because, inside of the positive electrode, the positive electrode active material includes the protruding portions, and the solid electrolyte is introduced around the positive electrode active material by the pattern forming device, and hence an area of an interface between the positive electrode active material and the solid electrolyte was increased so as to reduce the positive electrode resistance. In other words, when the protruding portions protrude in a plurality of directions from the particle portion so that the protruding portions are related to ion conductance between the electrolyte and the particle portion, the electrode resistance of the positive electrode is reduced. Further, it is considered that, when the active material having a surface in which a plurality of particle portions are arranged side by side is formed into an electrode for a battery as in this embodiment, ion conductance at an interface between the surface in which the particle portions are arranged side by side and the layer of the electrolyte is promoted, and the electrode resistance of the secondary battery is reduced.

Meanwhile, in Example 5 in which the positive electrode active material included the protruding portions, the removal of the base materials was insufficient, and the positive electrode resistance did not decrease. Thus, the charging and discharging were not detected. Further, in Examples 10 and 11 in which the positive electrode active material included the protruding portions, the heating was performed at high temperature, and hence a reaction layer was formed at the interface between the positive electrode active material (LCO) and the solid electrolyte (LAGP or LBO). Thus, the resistance was increased, and the charging and discharging were not detected.

In Examples, the positive electrode was formed on the separately-produced solid electrolyte sheet, but the positive electrode may be formed on a current collector such as an aluminum foil or a stainless steel foil. In this case, a positive electrode with a current collector (this formation) and a negative electrode (indium) may be fixed to both surfaces of the solid electrolyte sheet, and this sheet may be put into an Al lamination film together with a negative electrode current collector and a tab with a sealant, thereby being capable of forming the all-solid-state battery. Further, other than the positive electrode, the electrolyte and the negative electrode may be formed by a similar process. For example, a laminated body may be formed by laminating a base material for a positive electrode and a base material for a negative electrode on both surfaces of a solid electrolyte sheet, and the base materials may be removed by heating, thereby being capable of obtaining a formed body including the positive electrode, the electrolyte, and the negative electrode. As another example, a laminated body in which base materials for a positive electrode and for an electrolyte are laminated may be formed, and the base materials may be removed by heating. Further, a negative electrode (containing indium, metallic lithium, or the like) formed in a similar process or a different process may be laminated, thereby being capable of obtaining a formed body including the positive electrode, the electrolyte, and the negative electrode. As another example, a laminated body in which base materials for a positive electrode, for an electrolyte, and for a negative electrode are laminated may be formed, and the base materials may be removed by heating, thereby being capable of obtaining a formed body including the positive electrode, the electrolyte, and the negative electrode.

Further, another process may be added to the above-mentioned process so as to form the final all-solid-state battery. For example, after the base materials are removed by heating, the positive electrode may be filled with a solid electrolyte, a conductive assistant, or a binder resin. A solution is produced by mixing particles of at least one type of the above-mentioned materials with a solvent, and the positive electrode is immersed in the solution so that the solution is introduced. At this time, the positive electrode may include only the positive electrode active material as in Examples 1 to 3, or may include the positive electrode active material and the solid electrolyte as in Example 4. Further, other than the solid electrolyte sheet, an electrolyte including a semi-solid material, for example, a polymer electrolyte sheet, may be used.

### Example 12

A positive-pole electrode was produced through use of the above-mentioned additive manufacturing system 100, and the positive-pole electrode was applied to a lithium ion battery using a liquid electrolyte. Specifically, similarly to Example 1, the positive-pole electrode was produced by laminating three base materials each having a material layer (LCO) formed thereon on a current collector (aluminum foil of 20 μm), and removing the base materials. The coverage of the base material by the LCO was 80%.

### Example 13

A positive-pole electrode was produced through use of the above-mentioned additive manufacturing system 100, and the positive-pole electrode was applied to a lithium ion battery using a liquid electrolyte. Specifically, similarly to Example 3, the positive-pole electrode was produced by laminating three base materials each having a material layer (LCO) formed thereon on a current collector (aluminum foil of 20 μm), and removing the base materials. The coverage of the base material by the LCO was 60%.

### Comparative Example 3

A positive-pole electrode was produced through use of the above-mentioned additive manufacturing system 100, and the positive-pole electrode was applied to a lithium ion battery using a liquid electrolyte. Specifically, similarly to Comparative Example 1, the positive-pole electrode was produced by laminating one base material having a material layer (LCO) formed thereon on a current collector (aluminum foil of 20 μm), and removing the base materials. The coverage of the base material by the LCO was 80%.

### Example 14

A positive-pole electrode was produced through use of the above-mentioned additive manufacturing system 100, and the positive-pole electrode was applied to a lithium ion battery using a liquid electrolyte. Specifically, similarly to Example 4, the positive-pole electrode was produced by laminating three base materials each having a material layer (LCO+LBO) formed thereon on a current collector (aluminum foil of 20 μm), and removing the base materials. The coverage of the base material by the LCO and the LBO was 80%.

In order to check the performance of each electrode as a battery, the battery was assembled. A coin battery was assembled by laminating the positive-pole electrode, a separator, and a negative electrode sheet (graphite) in a coin case, applying pressure thereto, and filling the coin case with an electrolyte. As the negative electrode sheet, there was used a sheet obtained by applying a solvent including graphite, a binder resin, and the like onto a current collector by a coating process, drying the sheet, and applying pressure to the sheet, but, as another example, metallic lithium formed by a vapor protrusion process or the like may be used. Further, a material obtained by forming a negative electrode active material such as graphite or LTO on a current collector by a process similar to that of the positive electrode may be used.

[Evaluation Method]
Protruding portions: The lithium ion battery was disassembled after the impedance measurement and the charge and discharge measurement described below were performed, and the positive electrode was observed through use of the electron microscope to check the presence and absence of the protruding portions.
Rate: The charge and discharge measurement of the lithium ion battery was performed to check the rate at which the charge and discharge efficiency satisfies 80% or more (1C: amount of current at which the charging or discharging ends in 1 hour with respect to an actual capacity of the positive electrode active material).

The evaluation results are shown in Table 2 below.

TABLE 2
Evaluation results

| | Example | Example | Comparative | Example |
|---|---|---|---|---|
| | 12 | 13 | Example 3 | 14 |
| Presence/absence of | Present | Present | Absent | Present |
| needle-like portions | | | | |
| Rate (C) | 1.5 | 1.5 | 1.0 | 1.5 |

As compared to Comparative Example 3 in which the positive electrode active material did not include the protruding portions, the rate characteristics of Examples 12 to 14 in which the positive electrode active material included the protruding portions were improved. The reason is considered to be because, inside of the positive electrode, the positive electrode active material includes the protruding portions, and an area of an interface with respect to the introduced liquid electrolyte is increased so as to reduce the positive electrode resistance.

### Example 15

Through use of the above-mentioned additive manufacturing system 100, a positive-pole electrode was formed by using the produced LCO of Example 1 as a raw material, and the positive-pole electrode was applied to a lithium ion battery using a liquid electrolyte. A method of forming the positive-pole electrode is described. The produced positive electrode active material is sufficiently agitated and mixed with a binder resin, a conductive assistant, and a solvent, and the mixture is applied onto a current collector (aluminum foil). The positive electrode active material may be subjected to pre-treatment such as classification and pulverization treatment or surface treatment before being agitated and mixed. The current collector was dried and applied with pressure, and thus the positive-pole electrode was formed. The battery was assembled in the same manner as Example 4.

### Comparative Example 4

Through use of LCO in which the protruding portions were not protruding as a raw material, similarly to Example 4, a positive-pole electrode was formed, and the positive-pole electrode was applied to a lithium ion battery using a liquid electrolyte.

[Evaluation Method]

Protruding portions: The lithium ion battery was disassembled after the impedance measurement and the charge and discharge measurement described below were performed, and the positive electrode was observed through use of the electron microscope to check the presence and absence of the protruding portions.

Rate: The charge and discharge measurement of the lithium ion battery was performed to check the rate at which the charge and discharge efficiency satisfies 80% or more (1C: amount of current at which the charging or discharging ends in 1 hour with respect to an actual capacity of the positive electrode active material).

The evaluation results are shown in Table 3 below.

TABLE 3
Evaluation results

| | | Comparative |
|---|---|---|
| | Example 15 | Example 4 |
| Presence/absence of | Present | Absent |
| needle-like portions | | |
| Rate (C) | 1.3 | 1.0 |

As compared to Comparative Example 4 in which the positive electrode active material did not include the protruding portions, the rate characteristic of Example 15 in which the positive electrode active material included the protruding portions was improved. The reason is considered to be because, inside of the positive electrode, the positive electrode active material includes the protruding portions, and an area of an interface with respect to the introduced liquid electrolyte is increased so as to reduce the positive electrode resistance (electrode resistance).

According to the present invention, it is possible to provide the active material with which the interface between the active material and the electrolyte can be increased and ions can easily move to the electrolyte, the method of producing the active material, and the electrode and the battery using the active material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An active material comprising:
a particle portion; and
protruding portions protruding in a plurality of directions from the particle portion.

2. The active material according to claim 1, wherein the particle portion has a discontinuous texture.

3. The active material according to claim 1, wherein the particle portion includes a core portion and a shell portion.

4. The active material according to claim 3, further comprising a layered gap located between the core portion and the shell portion.

5. The active material according to claim 4,
wherein the shell portion comprises a plurality of shell portions present in a radial direction of the core portion, and
wherein the layered gap comprises a plurality of layered gaps present in the radial direction of the core portion.

6. The active material according to claim 3, wherein the particle portion has a radial gap in at least the shell portion.

7. The active material according to claim 3, wherein the protruding portions protrude from the shell portion.

8. The active material according to claim 7, wherein the protruding portions protrude from each of the shell portion and the core portion.

9. The active material according to claim 1, wherein the active material is a positive electrode active material.

10. The active material according to claim 9, wherein the positive electrode active material includes an oxide containing Li.

11. The active material according to claim 10, wherein the oxide contains Co.

12. The active material according to claim 10, wherein the oxide containing Li is included in each of the particle portion and the protruding portions.

13. The active material according to claim 11, wherein the oxide containing Co is included in each of the particle portion and the protruding portions.

14. The active material according to claim 1, wherein the active material comprises a plurality of the particle portions.

15. The active material according to claim 14, wherein the active material further comprises a gap in which an electrolyte is arrangeable between the plurality of the particle portions.

16. The active material according to claim 14, further comprising an electrolyte arranged between the plurality of the particle portions.

17. The active material according to claim 16, wherein the protruding portions protrude in the plurality of directions from the particle portion so that the protruding portions are related to ion conductance between the electrolyte and the particle portion.

18. An electrode for a battery comprising the active material of claim 14, and having a surface in which the plurality of the particle portions are arranged side by side.

19. A battery comprising:
a positive electrode active material;
a negative electrode active material; and
an electrolyte,
wherein the positive electrode active material is the active material included in the electrode of claim 18.

20. A method of producing an active material comprising:
a first step of forming a material layer by arranging, on a base material, a plurality of particles including an active material;
a second step of laminating a plurality of the material layers to form a laminated body; and
a third step of subjecting the laminated body to sintering treatment, to thereby produce an active material including protruding portions protruding in a plurality of directions from the plurality of particles including the active material.

21. The method of producing an active material according to claim 20, wherein the active material is a positive electrode active material.

22. The method of producing an active material according to claim 20, wherein the sintering treatment is performed by heating.

23. The method of producing an active material according to claim 22, wherein the heating of the laminated body is performed at a temperature of 400° C. or more and 800° C. or less.

24. The method of producing an active material according to claim 21, wherein the positive electrode active material includes an oxide containing Li.

25. The method of producing an active material according to claim 24, wherein the oxide further contains Co.

26. The method of producing an active material according to claim 20, further comprising a charge eliminating step between the first step and the second step.

27. The method of producing an active material according to claim 20, further comprising a pressure applying step between the second step and the third step.

28. The method of producing an active material according to claim 27, wherein the pressure applying step is performed by vacuum degassing.

29. The method of producing an active material according to claim 27, wherein the pressure applying step is performed by isostatic pressing.
